(19) United States
(12) Patent Application Publication
(10) Pub. No.: US 2020/0317828 A1
(43) Pub. Date: Oct. 8, 2020

(54) MODIFIED SOLID POLYMETHYLALUMINOXANE

(71) Applicant: SCG Chemicals Co., Ltd., Bangkok (TH)

(72) Inventors: Dermot O'Hare, Oxford (GB); Jean-Charles Buffet, Oxford (GB); Alexander Kilpatrick, Oxford (GB)

(21) Appl. No.: 16/758,287

(22) PCT Filed: Nov. 5, 2018
(86) PCT No.: PCT/GB2018/053206

§ 371 Date: Apr. 22, 2020

(30) Foreign Application Priority Data
Nov. 3, 2017 (GB) 1718277.5

(51) Int. Cl. C08F 4/659; C08F 210/02; C08G 79/10; C08F 4/642

(52) U.S. Cl. CPC C08F 4/65912; C08F 4/6428; C08G 79/10; C08F 210/02

(57) ABSTRACT

Modified solid polymethylaluminoxanes are described for use as support materials for olefin polymerisation catalysts. The modified solid polymethylaluminoxanes have higher specific surface areas than their unmodified analogues. Also described is a process for the preparation of the modified solid polymethylaluminoxanes and the use of the modified solid polymethylaluminoxanes as support materials in olefin polymerisation reactions.

### INTRODUCTION

The present invention relates to a modified solid polymethylaluminoxane, as well as to a process for the preparation of a modified solid polymethylaluminoxane. The present invention also relates to a catalytic composition comprising the modified solid polymethylaluminoxane on top of which is supported an olefin polymerisation catalyst. The present invention also relates to an olefin polymerisation process employing the catalytic compositions.

### BACKGROUND OF THE INVENTION

It is well known that ethylene (and α-olefins in general) can be readily polymerised at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

Catalytic reactions involving Ziegler-Natta catalysts, in particular metallocene-based catalysts, have traditionally employed the catalyst in solution phase. However, this technique has a number of drawbacks, most notably the difficulty of effectively separating the catalyst from the reaction medium and then recycling it for further use.

Given the high value that industry places on polyethylene (as well as other polyolefins), there is a need for improved solid-phase support materials capable of effectively supporting metallocene-based Ziegler-Natta catalysts.

The present invention was devised with the foregoing in mind.

### SUMMARY OF THE INVENTION

According to a first aspect of the present invention there is provided a modified solid polymethylaluminoxane, the modified solid polymethylaluminoxane comprising a solid polymethylaluminoxane comprising a repeating moiety having a structure according to formula (I) as defined herein, and at least one organic modifier having a structure according to formula (II) as defined herein, wherein at least a portion of the solid polymethylaluminoxane is associated with the organic modifier.

According to a second aspect of the present invention there is provided a process for the preparation of a modified solid polymethylaluminoxane according to the first aspect of the invention, the process comprising the steps of:

a) providing a solid polymethylaluminoxane comprising a repeating moiety having a structure according to formula (I) as defined herein,
b) contacting the solid polymethylaluminoxane of step a) with at least one organic modifier having a structure according to formula (II) as defined herein, and
c) isolating the product formed from step b), wherein the mole ratio of the organic modifier to the aluminium in the solid polymethylaluminoxane in step b) ranges from 0.001:1 to 0.45:1.

According to a third aspect of the present invention there is provided a modified solid polymethylaluminoxane obtainable, obtained or directly obtained by the process according to the second aspect of the invention.

According to a fourth aspect of the present invention, there is provided a catalytic composition comprising an olefin polymerisation catalyst supported on a modified solid polymethylaluminoxane according to the first or third aspect.

According to a fifth aspect of the present invention, there is provided a process for the preparation of a catalytic composition according to the fourth aspect, the process comprising the steps of:
a) providing, in a suitable solvent, a modified solid polymethylaluminoxane according to the first or third aspect of the invention;
b) contacting the modified solid polymethylaluminoxane with an olefin polymerisation catalyst having a structure according to formula (IV), and
c) isolating the product resulting from step b).

According to a sixth aspect of the present invention there is provided a process for the preparation of a polyolefin, the process comprising the step of:
a) contacting olefin monomers with a catalytic composition according to the fourth aspect of the invention.

### DETAILED DESCRIPTION OF THE INVENTION

### Definitions

The term “alkyl” as used herein refers to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein refers to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 2, 3, 4, 5 or 6 carbon atoms. The term includes reference to alkynyl moieties containing 1, 2 or 3 carbon-carbon triple bonds (C≡C). This term includes reference to groups such as ethynyl, propynyl, butynyl, pentynyl and hexynyl.

The term “alkoxy” as used herein refers to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “haloalkyl” as used herein refers to an alkyl group wherein at least one hydrogen has been substituted with a halo group selected from chloro, fluoro, bromo and iodo. Haloalkyl are typically, but not always, fluoroalkyls. This term includes reference to trifluoromethyl.

The terms “carbocyclyl”, “carbocyclic” and “carbocycle” as used herein refer to alicyclic moiety having 3, 4, 5, 6, 7 or 8 carbon atoms. The group may be a bridged or polycyclic ring system. More often carbocyclyl groups are monocyclic. This term includes reference to groups such as cyclopropyl, cyclobutyl, cyclopentyl, cyclohexyl, norbornyl, bicyclo[2.2.2]octyl and the like.

The terms “heterocyclyl”, “heterocyclic” and “heterocycle” as used herein refer to a saturated (e.g. heterocycloalkyl) or unsaturated (e.g. heteroaryl) heterocyclic ring moiety having from 3, 4, 5, 6, 7, 8, 9 or 10 ring atoms, at least one of which is selected from nitrogen, oxygen, phosphorus, silicon and sulphur. In particular, heterocyclyl includes a 3- to 10-membered ring or ring system and more particularly a 5- or 6-membered ring.

The terms “aryl” and “aromatic” as used herein refer to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The terms “heteroaryl” and “heteroaromatic” as used herein refers to an aromatic heterocyclic ring system having 5, 6, 7, 8, 9 or 10 ring atoms, at least one of which is selected from nitrogen, oxygen and sulphur. The group may be a polycyclic ring system, having two or more rings, at least one of which is aromatic, but is more often monocyclic. This term includes reference to groups such as pyrimidinyl, furanyl, benzo[b]thiophenyl, thiophenyl, pyrrolyl, imidazolyl, pyrrolidinyl, pyridinyl, benzo[b]furanyl, pyrazinyl, purinyl, indolyl, benzimidazolyl, quinolinyl, phenothiazinyl, triazinyl, phthalazinyl, 2H-chromenyl, oxazolyl, isoxazolyl, thiazolyl, isoindolyl, indazolyl, purinyl, isoquinolinyl, quinazolinyl, pteridinyl and the like.

The term “halogen” or “halo” as used herein refer to F, Cl, Br or I. In a particular, halogen may be F or CI, of which CI is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

### Modified Solid Polymethylaluminoxane

The first aspect of the invention provides a modified solid polymethylaluminoxane, the modified solid polymethylaluminoxane comprising:

a solid polymethylaluminoxane comprising a repeating moiety having a structure according to formula (I) shown below:

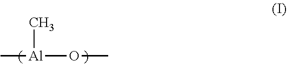

and at least one organic modifier having a structure according to formula (II) shown below:

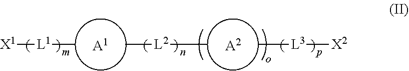

wherein
X¹ and X² are independently selected from OH, COOH, SH, PR^{x}R^{y}H and NR^{x}H, or their deprotonated forms;
rings A¹ and A² are independently aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
L¹, L² and L³ are independently selected from (1-5C)alkylene and phenylene, and are optionally substituted with one or more groups selected from OH, halo, (1-3C)alkyl and (1-3C)haloalkyl;
R^{x} and R^{y} are independently selected from hydrogen and (1-4C)alkyl;
m is 0 or 1;
n is 0 or 1;
o is 0 or 1; and
p is 0 or 1;
   and wherein at least a portion of the solid polymethylaluminoxane is associated with the organic modifier.

The modified solid polymethylaluminoxanes of the invention present a number of advantages over other solid polymethylaluminoxanes. Perhaps most notably, the modified solid polymethylaluminoxanes exhibit noticeably higher surface area than their unmodified analogues, thus rendering them ideal candidates for use as supporting materials in catalytic applications, in particular olefin polymerisation reactions. Owing to their superior surface area properties, the modified solid polymethylaluminoxanes are particularly effective support materials for the metallocene Ziegler-Natta-catalysed polymerisation of ethylene.

The modified solid polymethylaluminoxanes of the invention comprise a solid polymethylaluminoxane comprising a repeating moiety having a structure according to formula (I).

Solid polymethylaluminoxanes (also termed solid MAOs or sMAOs) comprising a repeating moiety having a structure according to formula (I) will be familiar to one of ordinary skill in the art. In particular, it will be understood that there exist numerous substantial structural and behavioural differences between solid polymethylaluminoxanes and other (non-solid) methyl aluminoxanes. Perhaps most notably, solid polymethylaluminoxanes are distinguished from other methyl aluminoxanes (MAOs) in that they are insoluble in hydrocarbon solvents and so may act as heterogeneous support systems. Any suitable solid polymethylaluminoxane may be used as part of the present invention.

The solid polymethylaluminoxanes useful in the preparation of the modified solid polymethylaluminoxanes of the invention are insoluble in toluene and hexane. In contrast to non-solid (hydrocarbon-soluble) MAOs, which are traditionally used as an activator species in slurry polymerisation or to modify the surface of a separate solid support material (e.g. SiO₂), the solid polymethylaluminoxanes useful as part of the present invention are themselves suitable for use as solid-phase support materials, without the need for an additional activator. Hence, the modified solid polymethylaluminoxanes of the invention are devoid of any other species that could be considered a solid support (e.g. inorganic material such as SiO₂, Al₂O₃ and ZrO₂). Similarly, when the modified solid polymethylaluminoxanes of the invention are used in olefin polymerisation applications, the only inorganic solid support present in the catalytic composition is the modified solid polymethylaluminoxanes (i.e. no additional solid support such as SiO₂, Al₂O₃ and ZrO₂ are necessary). Moreover, given the dual function of the modified solid polymethylaluminoxanes of the invention (as catalytic support and activator species), the catalytic compositions of the invention contain no additional catalytic activator species.

In an embodiment, the solid polymethylaluminoxanes used in the preparation of the modified solid polymethylaluminoxanes of the invention is prepared by heating a solution containing polymethylaluminoxane and a hydrocarbon solvent (e.g. toluene), so as to precipitate solid polymethylaluminoxane. The solution containing polymethylaluminoxane and a hydrocarbon solvent may be prepared by reacting trimethyl aluminium and benzoic acid in a hydrocarbon solvent (e.g. toluene), and then heating the resulting mixture. Accordingly, the solid polymethylaluminoxane and the resulting modified solid polymethylaluminoxanes of the invention may contain a quantity of residual benzoic acid and/or a quantity of trimethyl aluminium.

In an embodiment, the solid polymethylaluminoxane used in the preparation of the modified solid polymethylaluminoxanes of the invention is prepared according to the following protocol:

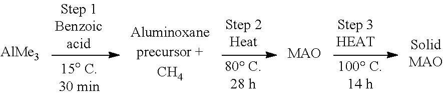

The properties of the solid polymethylaluminoxane can be adjusted by altering one or more of the processing variables used during its synthesis. For example, in the above-outlined protocol, the properties of the solid polymethylaluminoxane may be adjusted by varying the Al:O ratio, by fixing the amount of AlMe₃ and varying the amount of benzoic acid. Exemplary Al:O ratios are 1:1, 1.1:1, 1.2:1, 1.3:1, 1.4:1 and 1.6:1. Suitably the Al:O ratio is 1.2:1 or 1.3:1. Alternatively, the properties of the solid polymethylaluminoxane may be adjusted by fixing the amount of benzoic acid and varying the amount of AlMe₃.

In the above protocol, steps 1 and 3 may be kept constant, with step 2 being varied. The temperature of step 2 may be 70-100° C. (e.g. 70° C., 80° C., 90° C. or 100° C.). The duration of step 2 may be from 12 to 28 hours (e.g. 12, 20 or 28 hours). The duration of step 2 may be from κ minutes to 24 hours. Step 3 may be conducted in a solvent such as toluene.

In a particularly suitable embodiment, the solid polymethylaluminoxane used in the preparation of the modified solid polymethylaluminoxanes of the invention is as described in WO2010/055652 or WO2013/146337, and is obtainable from Tosoh Finechem Corporation, Japan. Suitably, the solid polymethylaluminoxane used in the preparation of the modified solid polymethylaluminoxanes of the invention is as described in WO2010/055652.

The solid polymethylaluminoxane used in the preparation of the modified solid polymethylaluminoxanes of the invention is characterised by having extremely low solubility in toluene and n-hexane. In an embodiment, the solubility in n-hexane at 25° C. of the solid polymethylaluminoxane is 0-2 mol %. Suitably, the solubility in n-hexane at 25° C. of the solid polymethylaluminoxane is 0-1 mol %. More suitably, the solubility in n-hexane at 25° C. of the solid polymethylaluminoxane is 0-0.2 mol %. Alternatively or additionally, the solubility in toluene at 25° C. of the solid polymethylaluminoxane is 0-2 mol %. Suitably, the solubility in toluene at 25° C. of the solid polymethylaluminoxane is 0-1 mol %. More suitably, the solubility in toluene at 25° C. of the solid polymethylaluminoxane is 0-0.5 mol %. The solubility in solvents may be measured by the method described in JP-B(KOKOKU)-H07 42301. The modified solid polymethylaluminoxanes of the invention may exhibit the same solubility properties as the solid polymethylaluminoxanes used in their preparation.

The solid polymethylaluminoxane used in the preparation of the modified solid polymethylaluminoxanes of the invention, or the modified solid polymethylaluminoxanes themselves, may have an aluminium content in the range of 36-41 wt %.

In an embodiment, the modified solid polymethylaluminoxanes have an aluminium content of 30.0-38.5 wt %. Suitably, the modified solid polymethylaluminoxanes have an aluminium content of 30.25-35.0 wt %. More suitably, the modified solid polymethylaluminoxanes have an aluminium content of 30.5-33.0 wt %.

The modified solid polymethylaluminoxanes of the invention comprise at least one organic modifier having a structure according to formula (II). At least a portion of the solid polymethylaluminoxane comprising a repeating moiety having a structure according to formula (I) is associated with the organic modifier. The association between the solid polymethylaluminoxane and the organic modifier can arise as a result of one or more different types of interaction, including ionic, covalent, hydrogen bonding and Van der Waals interactions. The nature of the interaction between the solid polymethylaluminoxane and the organic modifier has an influence of the structure of both components.

The organic modifier is typically associated with at least a portion of the solid polymethylaluminoxane via the former's X¹ and X² groups.

When the organic modifier is not covalently bonded to at least a portion of the solid polymethylaluminoxane, X¹ and X² may be selected from OH, COOH, SH, PR^{x}R^{y}H and NR^{x}H, in which case the organic modifier of formula (II) can be viewed as a free compound having a non-covalent association with at least a portion of the solid polymethylaluminoxane.

Alternatively, or additionally, when the organic modifier is covalently bonded to at least a portion of the solid polymethylaluminoxane, X¹ and X² may exist in a deprotonated form, in which case the organic modifier of formula (II) can be viewed as a structural moiety present within the modified solid polymethylaluminoxanes of the invention. Hence, in an embodiment, at least a portion of the solid polymethylaluminoxane is covalently bonded to the organic modifier, such that at least a portion of the modified solid polymethylaluminoxane has a structure according to formula (III) shown below:

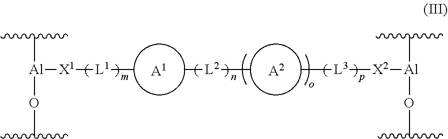

wherein

X¹ and X² are independently selected from O, COO, S, PR^{x}R^{y} and NR^{x}, and

A¹, A², L¹, L², L³, R^{x}, R^{y}, m, n, o and p are as defined in formula (II).

Without wishing to be bound by theory, it is believed that the structure of the organic modifiers of formula (II) has an effect on the overall morphology of the modified solid polymethylaluminoxane. In particular, the ability of groups X¹ and X² to each associate with a different particulate of solid polymethylaluminoxane comprising a repeating moiety having a structure according to formula (I) allows for the formation of a network of solid polymethylaluminoxane particulates interconnected by organic modifiers acting as linking groups. It is believed that the formation of such networks results in the creation of channels within the modified solid polymethylaluminoxane, which may contribute to the observed increase in specific surface area.

The following paragraphs provide preferred definitions of the groups X¹, X², A¹, A², L¹, L², L³, R^{x}, R^{y}, m, n, o and p of formula (II). It will be appreciated that when the organic modifier is covalently bonded to at least a portion of the solid polymethylaluminoxane, the definitions may be equally applicable to formula (III).

In an embodiment, X¹ and X² are independently selected from OH, COOH, SH, PR^{x}R^{y}H and NR^{x}H, or their deprotonated forms, wherein R^{x} is independently selected from hydrogen and (1-4C)alkyl.

In an embodiment, X¹ and X² are independently selected from OH, COOH, SH and NR^{x}H, or their deprotonated forms, wherein R^{x} is independently selected from hydrogen and (1-4C)alkyl.

In an embodiment, X¹ and X² are independently selected from OH, COOH and NR^{x}H, or their deprotonated forms, wherein R^{x} is independently selected from hydrogen and (1-4C)alkyl.

In an embodiment, X¹ and X² are independently selected from OH and NR^{x}H, or their deprotonated forms, wherein R^{x} is independently selected from hydrogen and (1-4C)alkyl.

In an embodiment, X¹ and X² are independently selected from OH and COOH, or their deprotonated forms.

In a particularly suitable embodiment, X¹ and X² are OH, or its deprotonated form.

In an embodiment, rings A¹ and A² are independently aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl, wherein R^{x} and R^{y} are independently selected from hydrogen and (1-4C)alkyl.

In an embodiment, rings A¹ and A² are independently monocyclic or bicyclic aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl, wherein R^{x} and R^{y} are independently selected from hydrogen and (1-4C)alkyl.

In an embodiment, rings A¹ and A² are independently monocyclic or bicyclic aromatic or heteroaromatic, and are optionally substituted with one or more groups R¹ selected from OH, COOH, NR^{x}R^{y}, halo, (1-5C)alkyl, (1-5C)alkoxy, phenyl and 5-6 membered heteroaryl, wherein R^{x} and R^{y} are independently selected from hydrogen and (1-4C)alkyl.

In an embodiment, rings A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl, wherein R^{x} and R^{y} are independently selected from hydrogen and (1-4C)alkyl.

In an embodiment, rings A¹ and A² are independently phenyl or naphthyl, and are optionally substituted with one or more groups R¹ selected from OH, COOH, NR^{x}R^{y}, halo, (1-5C)alkyl, (1-5C)alkoxy and phenyl, wherein R^{x} and R^{y} are independently selected from hydrogen and (1-4C)alkyl.

In an embodiment, rings A¹ and A² are independently phenyl or naphthyl, and are optionally substituted with one or more groups R¹ selected from OH, halo, (1-5C)alkyl and phenyl.

In an embodiment, rings A¹ and A² are independently phenyl or naphthyl, and are optionally substituted with one or more groups R¹ selected from OH, chloro, fluoro and (1-3C)alkyl.

In an embodiment, rings A¹ and A² independently have any one the following structures:

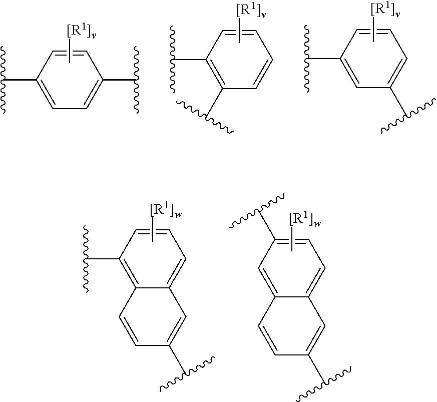

wherein

R¹ has any of the definitions outlined herein (e.g. halo, such as fluoro),

v is 0 to 4 (e.g. 0 or 4), and

w is 0 to 6 (e.g. 0).

In an embodiment, L¹, L² and L³ are independently selected from (1-5C)alkylene and phenylene, and are optionally substituted with one or more groups selected from OH, halo, (1-3C)alkyl and (1-3C)haloalkyl.

In an embodiment, L¹, L² and L³ are independently selected from (1-3C)alkylene and phenylene, and are optionally substituted with one or more groups selected from OH, halo, (1-3C)alkyl and (1-3C)haloalkyl.

In an embodiment, L¹, L² and L³ are independently selected from (1-3C)alkylene, and are optionally substituted with one or more groups selected from halo, (1-3C)alkyl and (1-3C)haloalkyl.

In an embodiment, L¹, L² and L³ are independently (1-3C)alkylene, and are optionally substituted with one or more groups selected from (1-3C)alkyl and (1-3C)haloalkyl.

In an embodiment, L¹, L² and L³ are methylene, and are optionally substituted with one or more groups selected from (1-2C)alkyl and (1-2C)fluoroalkyl.

In an embodiment, m is 0 or 1.

In an embodiment, m is 0.

In an embodiment, n is 0 or 1.

In an embodiment, n is 1.

In an embodiment, o is 0 or 1.

In an embodiment, o is 1.

In an embodiment, p is 0 or 1.

In an embodiment, p is 0.

In an embodiment, n is 1 and o is 1.

In an embodiment, m is 0 and p is 0.

In a particularly suitable embodiment, m is 0, n is 1, o is 1 and p is 0.

The following paragraphs outline preferred embodiments of the organic modifier of formula (II). It will be appreciated that when the organic modifier is covalently bonded to at least a portion of the solid polymethylaluminoxane, the embodiments may be equally applicable to formula (III).

In an embodiment, X¹ and X² are independently selected from OH, COOH, SH, PR^{x}R^{y}H and NR^{x}H, or their deprotonated forms;

A¹ and A² are independently monocyclic or bicyclic aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
R^{x} and R^{y} are independently selected from hydrogen and (1-4C)alkyl;
L² and L³ are independently selected from (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are independently selected from OH, COOH and NR^{x}H, or their deprotonated forms;

A¹ and A² are independently monocyclic or bicyclic aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
R^{x} and R^{y} are independently selected from hydrogen and (1-4C)alkyl;
L² and L³ are independently selected from (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are OH, or its deprotonated form;

A¹ and A² are independently monocyclic or bicyclic aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
R^{x} and R^{y} are independently selected from hydrogen and (1-4C)alkyl;
L¹, L² and L³ are independently selected from (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are OH, or its deprotonated form;

A¹ and A² are independently monocyclic or bicyclic aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
R^{x} and R^{y} are independently selected from hydrogen and (1-4C)alkyl;
L¹, L² and L³ are independently selected from (1-3C)alkylene and phenylene, and are optionally substituted with one or more groups selected from OH, halo, (1-3C)alkyl and (1-3C)haloalkyl;
m and p are independently 0 or 1;
n and o are 1.

In an embodiment, X¹ and X² are independently selected from OH, COOH, SH and NR^{x}H, or their deprotonated forms;

rings A¹ and A² are independently monocyclic or bicyclic aromatic or heteroaromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{x} and R^{y} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{x}H, or their deprotonated forms;

rings A¹ and A² are independently phenyl or naphthyl, and are optionally substituted with one or more groups R¹ selected from OH, COOH, NR^{x}R^{y}, halo, (1-5C)alkyl, (1-5C)alkoxy and phenyl;
R^{x} and R^{y} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{x}H, or their deprotonated forms;

rings A¹ and A² are independently phenyl or naphthyl, and are optionally substituted with one or more groups R¹ selected from OH, chloro, fluoro and (1-3C)alkyl;
R^{x} and R^{y} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{x}H, or their deprotonated forms;

rings A¹ and A² independently have any one the following structures:

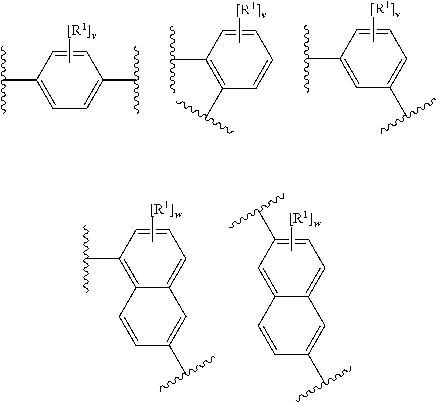

wherein

R¹ has any of the definitions outlined herein (e.g. halo, such as fluoro),

v is 0 to 4 (e.g. 0 or 4), and

w is 0 to 6 (e.g. 0);

R^{x} and R^{y} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m, n, o and p are independently 0 or 1.

In an embodiment, X¹ and X² are independently selected from OH, COOH, SH and NR^{x}H, or their deprotonated forms;

rings A¹ and A² independently have any one the following structures:

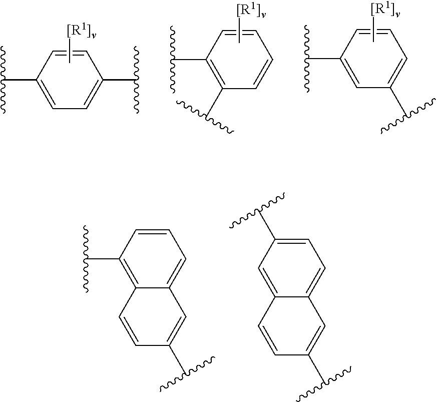

wherein

R¹ is selected from OH, COOH, NR^{x}R^{y}, halo (e.g. fluoro), (1-5C)alkyl, (1-5C)alkoxy and

phenyl, and

v is 0 or 4;

R^{x} and R^{y} are independently selected from hydrogen and (1-4C)alkyl;
L¹, L² and L³ are independently (1-3C)alkylene, and are optionally substituted with one or more groups selected from halo, (1-3C)alkyl and (1-3C)haloalkyl;
m and p are independently 0 or 1;
n and o are 1.

In an embodiment, X¹ and X² are independently selected from OH, COOH, SH and NR^{x}H, or their deprotonated forms;

A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{x} and R^{y} are independently selected from hydrogen and (1-4C)alkyl;
L¹, L² and L³ are independently selected from (1-5C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are independently selected from OH, COOH, SH and NR^{x}H, or their deprotonated forms;

A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{x} and R^{y} are independently selected from hydrogen and (1-4C)alkyl;
L¹, L² and L³ are independently (1-3C)alkylene, and are optionally substituted with one or more groups selected from (1-3C)alkyl and (1-3C)haloalkyl;
m, n, o and p are independently 0 or 1.

In an embodiment, X¹ and X² are independently selected from OH, COOH, SH and NR^{x}H, or their deprotonated forms;

A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{x} and R^{y} are independently selected from hydrogen and (1-4C)alkyl;
L¹, L² and L³ are methylene, and are optionally substituted with one or more groups selected from (1-2C)alkyl and (1-2C)fluoroalkyl;
m, n, o and p are independently 0 or 1.

In an embodiment, X¹ and X² are independently selected from OH, COOH, SH and NR^{x}H, or their deprotonated forms;

A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{x} and R^{y} are independently selected from hydrogen and (1-4C)alkyl;
L¹, L² and L³ are methylene, and are optionally substituted with one or more groups selected from (1-2C)alkyl and (1-2C)fluoroalkyl;
m and p are independently 0 or 1;
n and o are 1.

In an embodiment, X¹ and X² are independently selected from OH, COOH, SH and NR^{x}H, or their deprotonated forms;

rings A¹ and A² are independently monocyclic or bicyclic aromatic or heteroaromatic, and are optionally substituted with one or more groups R¹ selected from OH, COOH, NR^{x}R^{y}, halo, (1-5C)alkyl, (1-5C)alkoxy, phenyl and 5-6 membered heteroaryl;
R^{x} and R^{y} are independently selected from hydrogen and (1-4C)alkyl;
L¹, L² and L³ are independently (1-3C)alkylene and phenylene, and are optionally substituted with one or more groups selected from OH, halo, (1-3C)alkyl and (1-3C)haloalkyl;
m, n, o and p are independently 0 or 1.

In an embodiment, X¹ and X² are independently selected from OH, COOH and NR^{x}H, or their deprotonated forms;

rings A¹ and A² are independently phenyl or naphthyl, and are optionally substituted with one or more groups R¹ selected from OH, COOH, NR^{x}R^{y}, halo, (1-5C)alkyl, (1-5C)alkoxy and phenyl;
R^{x} and R^{y} are independently selected from hydrogen and (1-4C)alkyl;
L¹, L² and L³ are independently (1-3C)alkylene, and are optionally substituted with one or more groups selected from (1-3C)alkyl and (1-3C)haloalkyl;
m and p are independently 0 or 1;
n and o are 1.

In an embodiment, X¹ and X² are independently selected from OH and COOH, or their deprotonated forms;

rings A¹ and A² are independently phenyl or naphthyl, and are optionally substituted with one or more groups R¹ selected from OH, chloro, fluoro and (1-3C)alkyl;
L¹, L² and L³ are methylene, and are optionally substituted with one or more groups selected from (1-2C)alkyl and (1-2C)fluoroalkyl;
m and p are independently 0 or 1;
n and o are 1.

In an embodiment, X¹ and X² are independently selected from OH and COOH (e.g. OH), or their deprotonated forms;

ring A¹ is unsubstituted phenyl or phenyl substituted with one, two, three or four (e.g. three or four) groups R¹ selected from chloro and fluoro (e.g. fluoro); and
m, n, o and p are 0.

In an embodiment, X¹ and X² are OH or its deprotonated form;

ring A¹ is phenyl substituted with three or four groups R¹ being fluoro; and
m, n, o and p are 0.

In an embodiment, X¹ and X² are OH, or its deprotonated form;

rings A¹ and A² independently have any one the following structures:

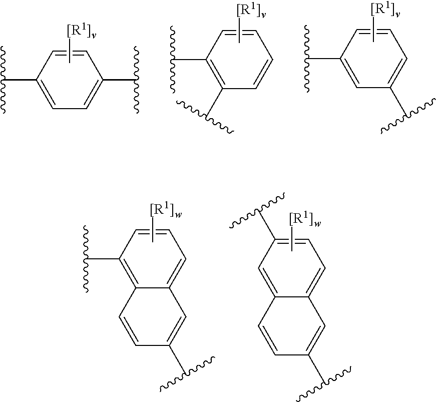

wherein

R¹ has any of the definitions outlined herein (e.g. halo, such as fluoro),

v is 0 to 4 (e.g. 0 or 4), and

w is 0 to 6 (e.g. 0).

L¹, L² and L³ are methylene, and are optionally substituted with one or more groups selected from (1-2C)alkyl and (1-2C)fluoroalkyl;
m and p are independently 0 or 1;
n and o are 1.

In an embodiment, X¹ and X² are OH, or its deprotonated form;

ring A¹ has any one of the following structures:

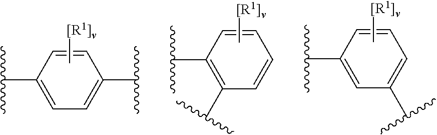

wherein

each R¹ is independently chloro or fluoro (e.g. fluoro), and

v is 0, 1, 2, 3 or 4 (e.g. 0, 3 or 4); and

m, n, o and p are 0.

In an embodiment, X¹ and X² are OH, or its deprotonated form;

ring A¹ has the following structure:

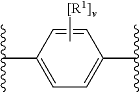

wherein

each R¹ is independently chloro or fluoro (e.g. fluoro), and
v is 0, 1, 2, 3 or 4 (e.g. 0, 3 or 4); and
   m, n, o and p are 0.

In an embodiment, X¹ and X² are OH, or its deprotonated form;

ring A¹ has the following structure:

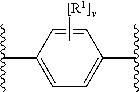

wherein

each R¹ is fluoro, and

v is 3 or 4; and

m, n, o and p are 0.

In an embodiment, the organic modifier has any one or more of the following structures:

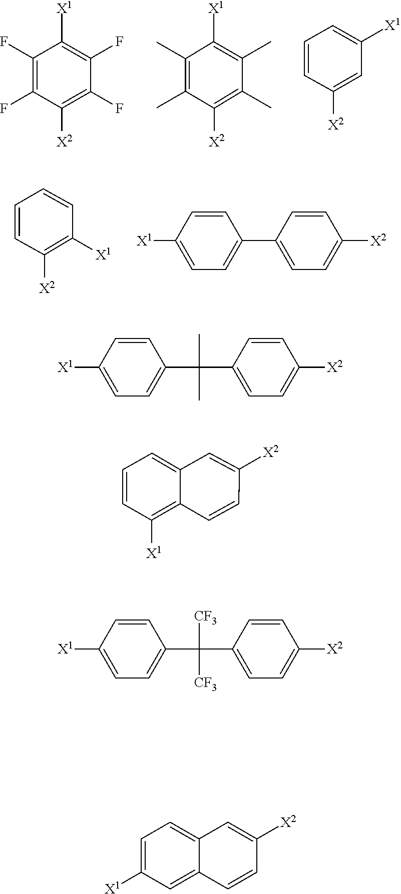

wherein X¹ and X² are independently selected from OH, COOH, SH, PR^{x}R^{y}H and NR^{x}H, or their deprotonated forms, wherein R^{x} and R^{y} are independently selected from hydrogen and (1-4C)alkyl. Suitably, X¹ and X² are independently selected from OH, COOH, SH and NR^{x}H, or their deprotonated forms, wherein R^{x} is independently selected from hydrogen and (1-4C)alkyl. More suitably, X¹ and X² are independently selected from OH, COOH and NR^{x}H, or their deprotonated forms, wherein R^{x} is independently selected from hydrogen and (1-4C)alkyl. Most suitably, X¹ and X² are OH, or its deprotonated form.

The amount of organic modifier of formula (II) within the modified solid polymethylaluminoxane is calculated relative to the number of moles of aluminium within the solid polymethylaluminoxane comprising a repeating moiety of formula (I). The amount of organic modifier within a sample of modified solid polymethylaluminoxane can be determined by techniques such as elemental analysis and NMR spectroscopy.

In an embodiment, the modified solid polymethylaluminoxane comprises 0.1-45 mol % of organic modifier of formula (II) relative to the number of moles of aluminium within the solid polymethylaluminoxane comprising a repeating moiety of formula (I). Suitably, the modified solid polymethylaluminoxane comprises 0.1-20 mol % of organic modifier of formula (II) relative to the number of moles of aluminium within the solid polymethylaluminoxane comprising a repeating moiety of formula (I). Suitably, the modified solid polymethylaluminoxane comprises 0.5-15 mol % of organic modifier of formula (II) relative to the number of moles of aluminium within the solid polymethylaluminoxane comprising a repeating moiety of formula (I). More suitably, the modified solid polymethylaluminoxane comprises 1-5 mol % of organic modifier of formula (II) relative to the number of moles of aluminium within the solid polymethylaluminoxane comprising a repeating moiety of formula (I). Yet more suitably, the modified solid polymethylaluminoxane comprises 1.5-3.5 mol % of organic modifier of formula (II) relative to the number of moles of aluminium within the solid polymethylaluminoxane comprising a repeating moiety of formula (I). Yet even more suitably, the modified solid polymethylaluminoxane comprises 2.0-3.0 mol % of organic modifier of formula (II) relative to the number of moles of aluminium within the solid polymethylaluminoxane comprising a repeating moiety of formula (I). Yet even more suitably, the modified solid polymethylaluminoxane comprises 2.2-2.8 mol % of organic modifier of formula (II) relative to the number of moles of aluminium within the solid polymethylaluminoxane comprising a repeating moiety of formula (I). Most suitably, the modified solid polymethylaluminoxane comprises 2.35-2.65 mol % of organic modifier of formula (II) relative to the number of moles of aluminium within the solid polymethylaluminoxane comprising a repeating moiety of formula (I)

At least a portion of the organic modifier of formula (II) present within the modified solid polymethylaluminoxane is associated with the solid polymethylaluminoxane comprising a repeating moiety of formula (I). In an embodiment, at least 30% of the organic modifier of formula (II) present within the modified solid polymethylaluminoxane is associated with the solid polymethylaluminoxane comprising a repeating moiety of formula (I). Suitably, at least 50% of the organic modifier of formula (II) present within the modified solid polymethylaluminoxane is associated with the solid polymethylaluminoxane comprising a repeating moiety of formula (I). More suitably, at least 80% of the organic modifier of formula (II) present within the modified solid polymethylaluminoxane is associated with the solid polymethylaluminoxane comprising a repeating moiety of formula (I).

The modified solid polymethylaluminoxane may have a specific surface area (calculated by N₂ physisorbtion using Brunauer-Emmett-Teller (BET) theory) of >10 m² g⁻¹ (e.g. 10-50 m² g⁻¹). Suitably, the modified solid polymethylaluminoxane has a specific surface area of >14 m² g⁻¹ (e.g. 14-50 m² g⁻¹). More suitably, the modified solid polymethylaluminoxane has a specific surface area of >18 m² g⁻¹ (e.g. 18-45 m² g⁻¹). Most suitably, the modified solid polymethylaluminoxane has a specific surface area of >20 m² g⁻¹ (e.g. 20-40 m² g⁻¹).

### Preparation of Modified Solid Polymethylaluminoxane

The second aspect of the invention provides a process for the preparation of a modified solid polymethylaluminoxane according to the first aspect of the invention, the process comprising the steps of:
a) providing, in a first solvent, a solid polymethylaluminoxane comprising a repeating moiety having a structure according to formula (I) shown below:

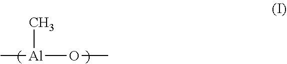

b) contacting the solid polymethylaluminoxane of step a) with at least one organic modifier having a structure according to formula (II) shown below:

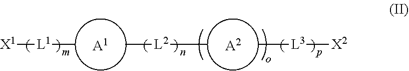

wherein
   X¹ and X² are independently selected from OH, COOH, SH, PR^{x}R^{y}H and NR^{x}H, or their deprotonated forms;
   rings A¹ and A² are independently aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
   L¹, L² and L³ are independently selected from (1-5C)alkylene and phenylene, and are optionally substituted with one or more groups selected from OH, halo, (1-3C)alkyl and (1-3C)haloalkyl;
   R^{x} and R^{y} are independently selected from hydrogen, OH and (1-4C)alkyl;
   m is 0 or 1;
   n is 0 or 1;
   o is 0 or 1; and
   p is 0 or 1;
c) isolating the product formed from step b);
wherein the mole ratio of the organic modifier to the aluminium in the solid polymethylaluminoxane in step b) ranges from 0.001:1 to 0.45:1.

It will be appreciated that the solid polymethylaluminoxane comprising a repeating moiety having a structure according to formula (I) may be as defined in any of those embodiments outlined hereinbefore in respect of the first aspect of the invention.

It will be appreciated that the organic modifier having a structure according to formula (II) may be as defined in any of those embodiments outlined hereinbefore in respect of the first aspect of the invention.

In an embodiment, the mole ratio of the organic modifier to the aluminium in the solid polymethylaluminoxane in step b) ranges from 0.005:1 to 0.2:1. Suitably, the mole ratio of the organic modifier to the aluminium in the solid polymethylaluminoxane in step b) ranges from 0.005:1 to 0.15:1. Suitably, the mole ratio of the organic modifier to the aluminium in the solid polymethylaluminoxane in step b) ranges from 0.01:1 to 0.05:1. More suitably, the mole ratio of the organic modifier to the aluminium in the solid polymethylaluminoxane in step b) ranges from 0.015:1 to 0.035:1. Even more suitably, the mole ratio of the organic modifier to the aluminium in the solid polymethylaluminoxane in step b) ranges from 0.02:1 to 0.03:1. Yet even more suitably, the mole ratio of the organic modifier to the aluminium in the solid polymethylaluminoxane in step b) ranges from 0.022:1 to 0.028:1. Most suitably, the mole ratio of the organic modifier to the aluminium in the solid polymethylaluminoxane in step b) ranges from 0.0235:1 to 0.0265:1.

In an embodiment, the first solvent is selected from toluene, benzene and hexane. Suitably the first solvent is toluene.

In an embodiment, the organic modifier is provided in a second solvent, and step b) comprises mixing the first solvent and the second solvent. The second solvent may be selected from toluene, benzene and hexane. Suitably, the second solvent is toluene.

In an embodiment, step b) is conducted at a temperature of 10-150° C. Suitably, step b) is conducted at a temperature of 10-65° C. More suitably, step b) is conducted at a temperature of 18-50° C. Yet more suitably, step b) is conducted at a temperature of 18-35° C.

In an embodiment, step b) further comprises the step of sonicating the mixture of the solid polymethylaluminoxane and the organic modifier, for example at an ultrasonic frequency of >15 kHz. The use of sonication advantageously obviates the need for conducting step b) at high temperatures, which is believed to result in degradation of the modified solid polymethylaluminoxane. In an embodiment, when step b) comprises sonicating the mixture of the solid polymethylaluminoxane and the organic modifier, the temperature of the mixture does not rise above 85° C. over the course of step b). Suitably, when step b) comprises sonicating the mixture of the solid polymethylaluminoxane and the organic modifier, the temperature of the mixture does not rise above 65° C. over the course of step b).

In an embodiment, step b) is carried out under soniciation for a period of 0.1 to 24 hours. Suitably, step b) is carried out under soniciation for a period of 0.1 to 5 hours.

### Catalytic Composition

The fourth aspect of the invention provides a catalytic composition comprising an olefin polymerisation catalyst supported on a modified solid polymethylaluminoxane according to the first or third aspect.

Any suitable olefin polymerisation catalyst may be used in the catalytic composition. In an embodiment, the olefin polymerisation catalyst is a Ziegler-Natta type catalyst (e.g. a metallocene-based Ziegler-Natta catalyst).

In an embodiment, the olefin polymerisation catalyst is a metallocene catalyst comprising a metal bound between two η⁵-cyclopentadienyl type ligands. The η⁵-cyclopentadienyl type ligands may be selected from η⁵-cyclopentadienyl, η⁵-pentalenyl, η⁵-indenyl and η⁵-fluorenyl.

In an embodiment, the olefin polymerisation catalyst has a structure according to formula (IV) shown below:

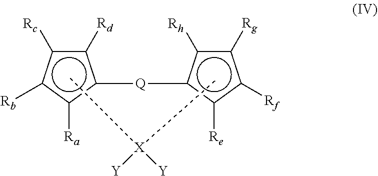

wherein
Rₐ and R_{b} are each independently hydrogen or (1-2C)alkyl;
R_{c} and R_{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro and cyano;
Q is absent (in which case each cyclopentadienyl ring is bound to hydrogen at this position), or is a bridging group selected from —CH₂— or —CH₂CH₂—, either or which may be optionally substituted with one or more groups selected from (1-4C)alkyl, (2-4C)alkenyl, (2-4C)alkynyl and aryl, or Q is a bridging group —Si(Rᵢ)(Rⱼ)—,
   wherein Rᵢ and Rⱼ are independently (1-4C)alkyl, (2-4C)alkenyl, (2-4C)alkynyl or aryl;
X is zirconium or hafnium; and
each Y group is independently selected from halo, hydride, (1-6C)alkyl, (1-6C)alkoxy, aryl or aryloxy, either or which is optionally substituted with one or more groups selected from (1-6C)alkyl and halo.

It will be appreciated that the structural formula (IV) presented above is intended to show the substituent groups in a clear manner. A more representative illustration of the spatial arrangement of the groups is shown in the alternative representation below:

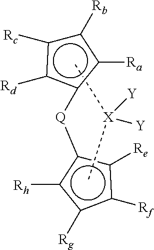

It will also be appreciated that, depending on the identities of substituents Rₐ-Rₕ, the compound of formula (IV) may be present as meso or rac isomers, and the present invention includes both such isomeric forms. A person skilled in the art will appreciate that a mixture of isomers of the compound of formula (IV) may be used for catalysis applications, or the isomers may be separated and used individually (using techniques well known in the art, such as, for example, fractional crystallization).

If the structure of a compound of formula (IV) is such that rac and meso isomers do exist, the compound may be present in the rac form only, or in the meso form only.

The compound of formula (IV) may be immobilized on the solid phase support material by one or more ionic or covalent interactions.

In the catalytic compositions of the invention, the modified solid polymethylaluminoxane of the invention are the only inorganic solid supports used (i.e. no additional solid support such as SiO₂, Al₂O₃ and ZrO₂ are necessary). Moreover, given the dual function of the modified solid polymethylaluminoxane of the invention (as catalytic support and activator species), the catalytic compositions of the invention contain no additional catalytic activator species (e.g. co-catalysts).

The respective amounts of the modified solid polymethylaluminoxane and the compound of formula (IV) within the catalytic composition of the invention is expressed by mol_{Al}/mol_{X} (i.e. the number of moles of Al (from the modified solid polymethylaluminoxane) divided by the number of moles of metal X (from the compound of formula (IV)). In an embodiment, mol_{Al}/mol_{X} is 25-250. Suitably, mol_{Al}/mol_{X} is 40-225. More suitably, mol_{Al}/mol_{X} is 75-225. Even more suitably, mol_{Al}/mol_{X} is 100-225. Yet more suitably, mol_{Al}/mol_{X} is 125-225. Yet even more suitably, mol_{Al}/mol_{X} is 150-225. Most suitably, mol_{Al}/mol_{X} is 175-225.

In an embodiment, Rₐ and R_{b} are each hydrogen.

In an embodiment, R_{c} and R_{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl and (1-6C)alkoxy.

Suitably, R_{c} and R_{d} are each independently hydrogen or (1-4C)alkyl, or R_{c} and R_{d} are linked such that, when taken in combination with the atoms to which they are attached, they form a 6-membered fused aromatic ring optionally substituted with one or more groups selected from methyl, ethyl and tert-butyl.

In an embodiment, Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from (1-6C)alkyl, (2-6C)alkenyl, (2-6C)alkynyl and (1-6C)alkoxy.

Suitably, Rₑ and R_{f} are each independently hydrogen or (1-4C)alkyl, or Rₑ and R_{f} are linked such that, when taken in combination with the atoms to which they are attached, they form a 6-membered fused aromatic ring optionally substituted with one or more groups selected from methyl, ethyl and tert-butyl.

In an embodiment, R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl and (1-6C)alkoxy.

Suitably, R_{g} and Rₕ are each independently hydrogen or (1-4C)alkyl, or R_{g} and Rₕ are linked such that, when taken in combination with the atoms to which they are attached, they form a 6-membered fused aromatic ring optionally substituted with one or more groups selected from methyl, ethyl and tert-butyl.

In an embodiment, Q is absent, or is a bridging group selected from —CH₂— or —CH₂CH₂—, either or which may be optionally substituted with one or more groups selected from (1-4C)alkyl and phenyl, or Q is a bridging group —Si(Rᵢ)(Rⱼ)—,

wherein Rᵢ and Rⱼ are independently (1-4C)alkyl or aryl.

In an embodiment, X is zirconium.

In an embodiment, each Y group is independently selected from halo.

Suitably, each Y group is chloro.

In an embodiment, the olefin polymerisation catalyst having a structure according to formula (IV) has any of the structures shown below:

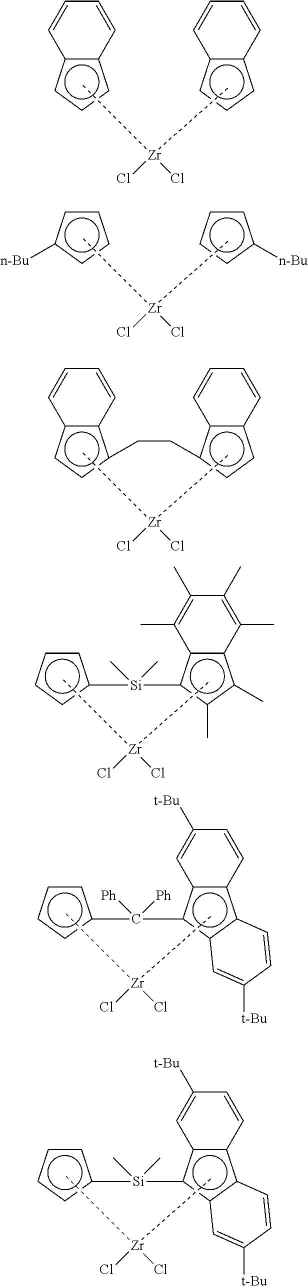

In a particular embodiment, the olefin polymerisation catalyst has a structure according to formula (IV) has the following structure:

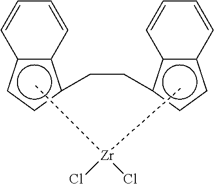

### Preparation of Catalytic Compositions

The fifth aspect of the invention provides a process for the preparation of a catalytic composition according to the fourth aspect, the process comprising the steps of:
a) providing, in a suitable solvent, a modified solid polymethylaluminoxane according to the first or third aspect of the invention;
b) contacting the modified solid polymethylaluminoxane with an olefin polymerisation catalyst, and
c) isolating the product resulting from step b).

The olefin polymerisation catalyst may have any of those definitions discussed hereinbefore in respect of the fourth aspect of the invention.

The catalytic compositions of the invention are straightforwardly prepared using mild reaction conditions.

Suitable solvents for use in step a) will be well known to one of ordinary skill in the art, and include toluene, o-xylene, mesitylene, pentane, hexane, heptane, cyclohexane and methylcyclohexane. Suitably, the solvent used in step a) is toluene.

Step b) may involve mixing the reagents for a period of 0.05-6 hours. Step b) may be conducted at a temperature of 1-3 hours.

### Applications

The sixth aspect of the invention provides a process for the preparation of a polyolefin, the process comprising the step of:
a) contacting olefin monomers with a catalytic composition according to the fifth aspect of the invention.

In an embodiment, the polyolefin is polyethylene and the olefin monomers are ethene monomers.

In another embodiment, the polyolefin is a copolymer, and the olefin monomers are a mixture of monomers comprising 90-99 wt % ethene and 1-10 wt % of one or more (4-8C) α-olefin. Suitably, the (4-8C) α-olefin is 1-butene, 1-hexene, 1-octene, or a mixture thereof.

A person skilled in the art of olefin polymerisation will be able to select suitable reaction conditions (e.g. temperature, pressures, reaction times etc.) for such a polymerisation reaction. A person skilled in the art will also be able to manipulate the process parameters in order to produce a polyolefin having particular properties

### EXAMPLES

One or more examples of the invention will now be described, for the purpose of illustration only, with reference to the accompanying figures, in which:

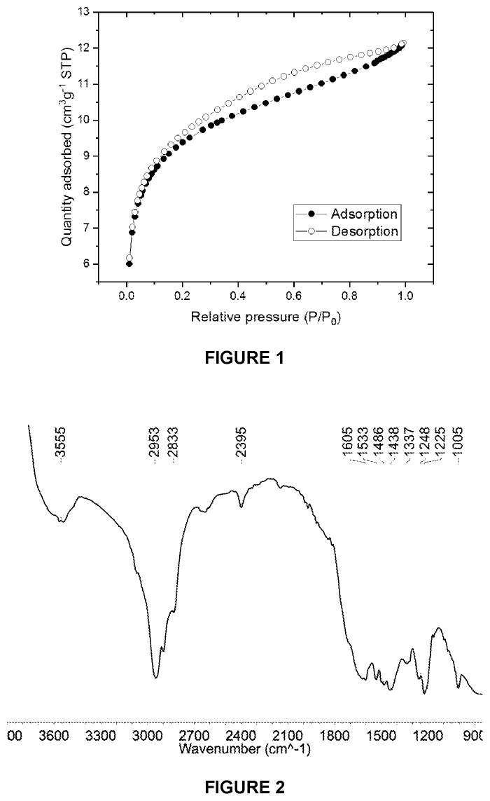

FIG. 1 shows the BET adsorption/desorption isotherm for sMMAO(0.025/1,4-HO(C₆F₄)OH).

FIG. 2 shows the DRIFT spectrum (NaCl window) of sMMAO(0.025/1,4-HO(C₆F₄)OH).

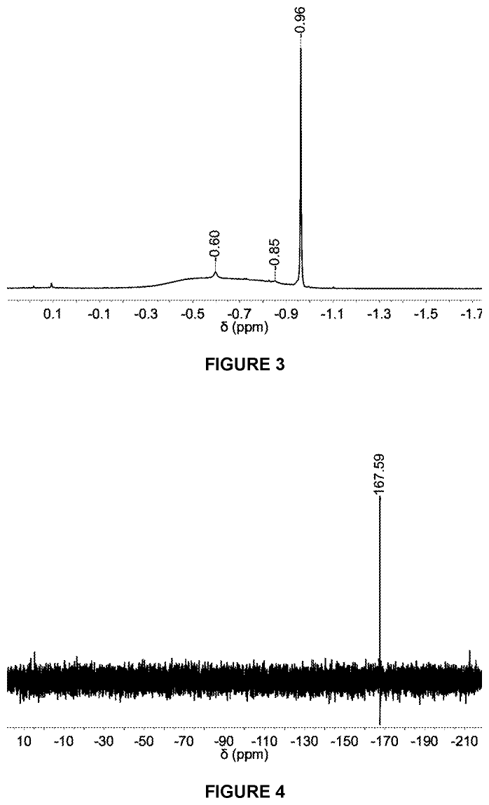

FIG. 3 shows a selected region of the ¹H NMR spectrum in d₈-THF of solid MAO modified with 1,4-HO(C₆F₄)OH at 2.5 mol % loading.

FIG. 4 shows the ¹⁹F{¹H} NMR spectrum in d₈-THF of solid MAO modified with 1,4-HO(C₆F₄)OH at 2.5 mol % loading.

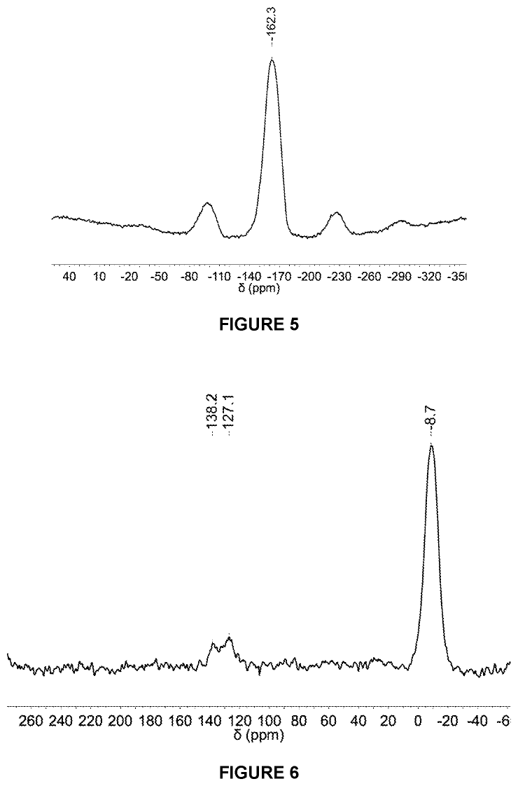

FIG. 5 shows the ¹⁹F{¹H} DP-MAS SSNMR spectrum (24 kHz spinning) of solid MAO modified with 1,4-HO(C₆F₄)OH at 5 mol % loading.

FIG. 6 shows the ¹H→¹³C{¹⁹F} CP-MAS SSNMR spectrum (10 kHz spinning) of solid MAO modified with 1,4-HO(C₆F₄)OH at 5 mol % loading.

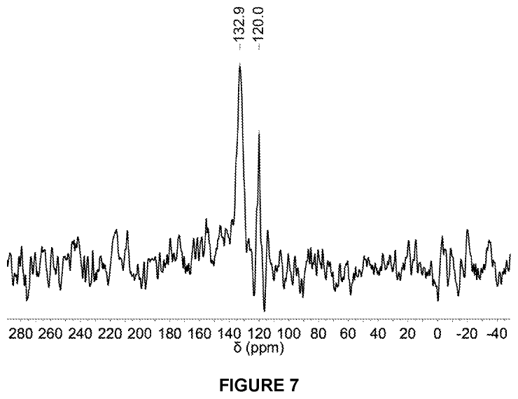

FIG. 7 shows ¹⁹F→¹³C{¹H} CP-MAS SSNMR spectrum (10 kHz spinning) of solid MAO modified with 1,4-HO(C₆F₄)OH at 5 mol % loading.

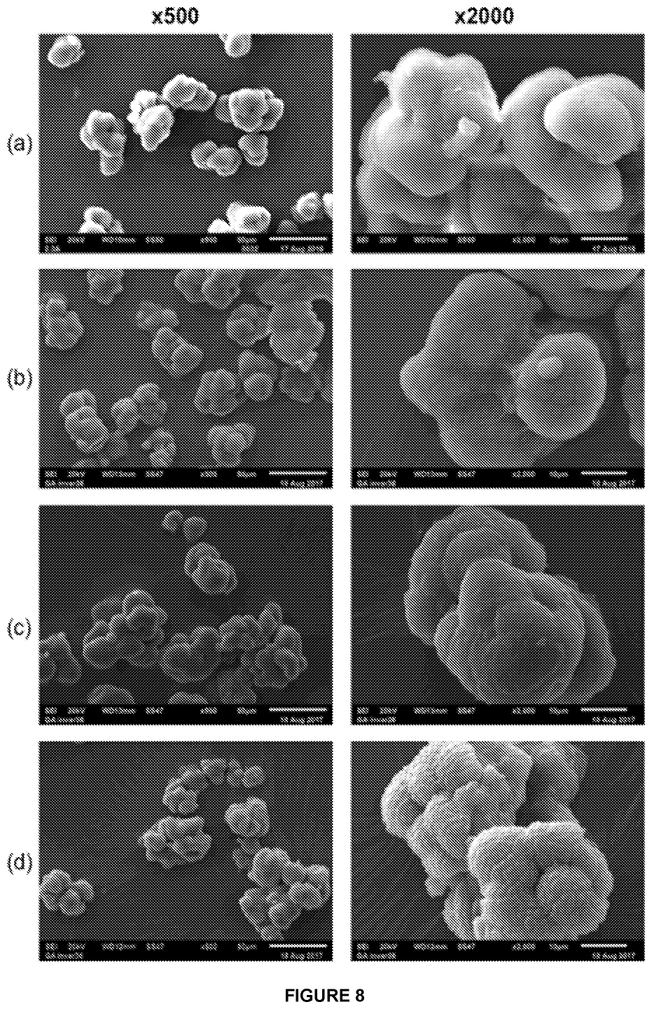

FIG. 8 shows SEM images (×500 and ×2,000 magnification) of PE samples from catalysts based on (a) unmodified and (b)-(d) sMMAO(x/HOC₆F₄OH) for x=0.01, 0.025, 0.05.

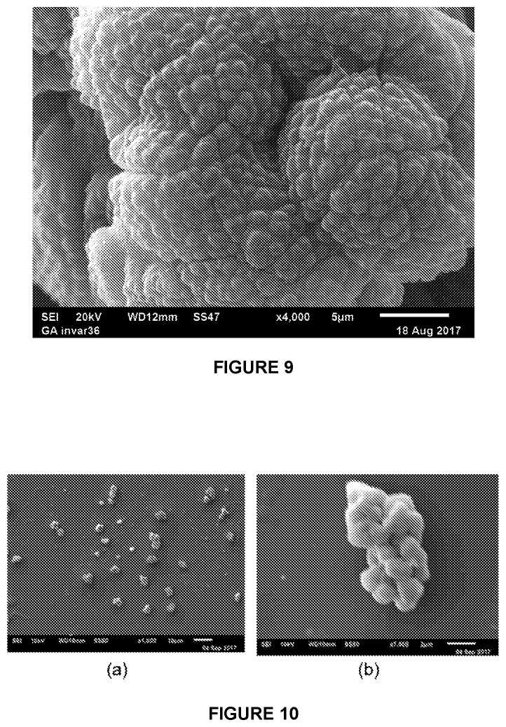

FIG. 9 shows an SEM image (×4,000 magnification) of PE samples from a catalyst based on sMMAO(0.05/HOC₆F₄OH).

FIG. 10 shows SEM images of sMAO samples modified with HO(C₆H₄)—(C₆H₄)OH at 2.5 mol % loading at (a) ×500 and (b) ×7,500 magnification.

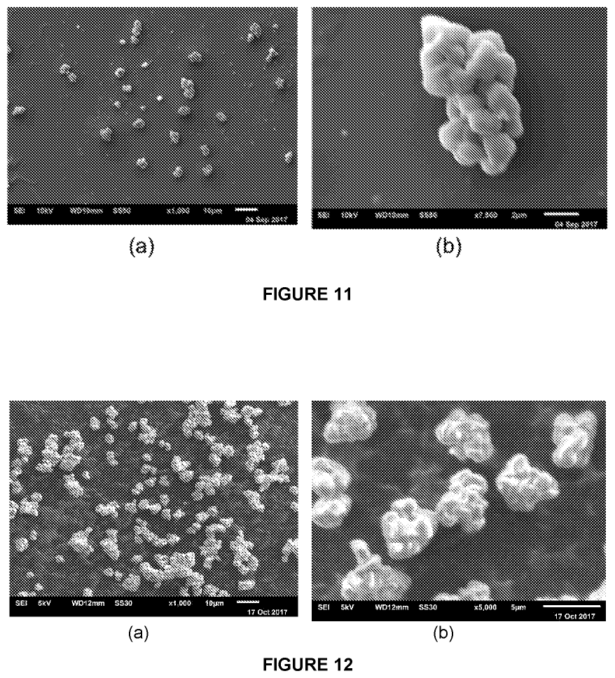

FIG. 11 shows SEM images of sMAO samples modified with 1,2-HO(C₆H₄)OH at 2.5 mol % loading at (a) ×1,000 and (b) ×7,500 magnification.

FIG. 12 shows SEM images of sMAO samples modified with 1,4-HO(C₆F₄)OH at 2.5 mol % loading at (a) ×1,000 and (b) ×5,000 magnification.

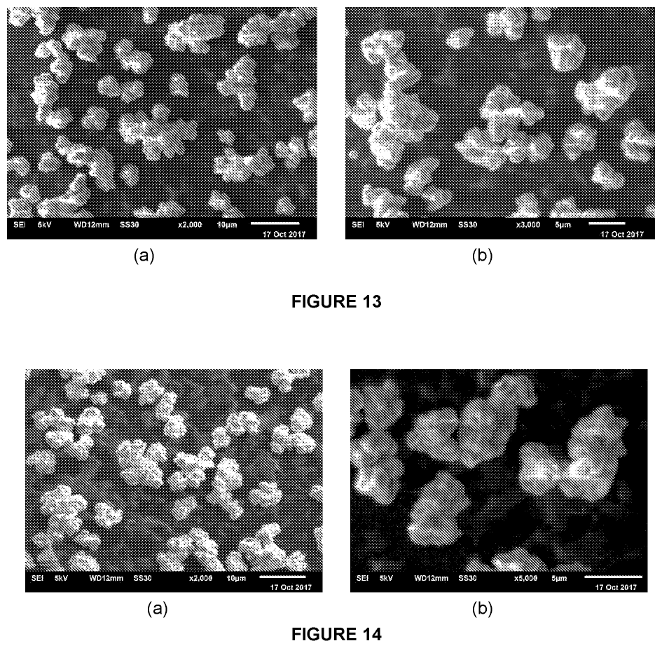

FIG. 13 shows SEM images of sMAO samples modified with 1,4-HO(C₆H₄)OH at 2.5 mol % loading at (a) ×2,000 and (b) ×3,000 magnification.

FIG. 14 shows SEM images of sMAO samples modified with HO(C₆H₄)—(C₆H₄)OH at 2.5 mol % loading at (a) ×2,000 and (b) ×5,000 magnification.

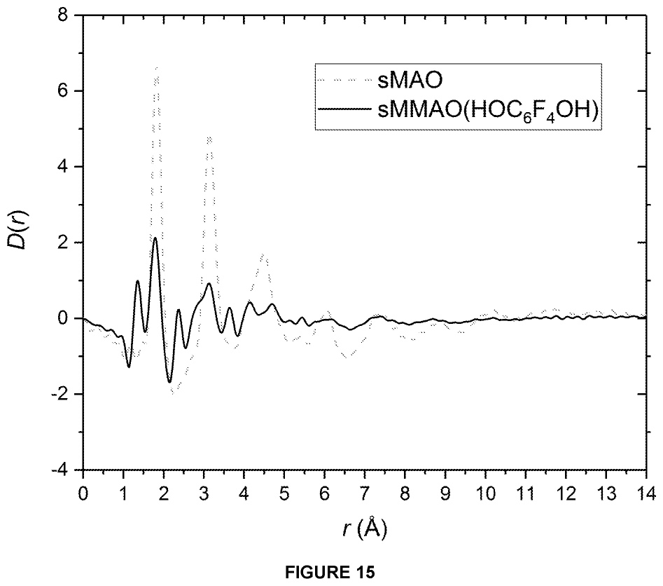

FIG. 15 shows the PDF overlay for sMAO (in grey, dashed line) and sMMAO(0.40/1,4-HO(C₆F₄)OH) (black, solid line)

### Example 1—Synthesis and Characterisation of Modified Solid Polymethylaluminoxanes

### 1.1 Synthesis

A study into the effect of various aromatic di-ol modifying compounds (M) on solid polymethylaluminoxane was carried out, using a M:Al mol ratio of 0.025.

In a typical experiment, solid polymethylaluminoxane (sMAO, supplied by TOSOH Finechem) was suspended in toluene and a solution of the modifier in toluene was added. In the case of the modifiers which showed poor toluene solubility, the two solid reagents were combined in the same Schlenk flask, to which toluene was added. The mixture was sonicated for 1 h, during which time the temperature increased from 25 to 45° C.

Upon addition of these aromatic di-ol modifiers to sMAO, effervescence was observed, confirming a protonolysis reaction with concomitant release of methane gas. A control reaction was also carried out, using an identical procedure but without the addition of a modifying compound.

After cooling to room temperature, the resultant slurry was then treated with hexane to extract by-products and encourage precipitation of a colourless solid. After settling, the supernatant solution was removed and the solid modified polymethylaluminoxane (sMMAO) samples were vacuum dried and isolated in good yield (59-91%).

For completeness, a detailed synthetic protocol using 1,4-HO(C₆F₄)OH as the modifier is outlined below.

To a round-bottom flask containing a dispersion of sMAO (680 mg, 10.07 mmol_{Al}) in toluene (5 mL) was added a solution of 1,4-HO(C₆F₄)OH (46 mg, 0.253 mmol) in toluene (3×5 mL) and the flask was swirled at ambient temperature for 1 h. Hexane (60 mL) was added and the resultant off-white suspension was allowed to settle. The supernatant solution was removed by filtration and the remaining solids were dried in vacuo for 3 h, to afford sMMAO(0.025/1,4-HO(C₆F₄)OH) as a free-flowing white solid. Total yield: 593 mg, 6.92 mmol_{Al} (69% based on aluminum).

Once prepared, the various sMMAO(0.025/M) samples were characterised using BET isotherm, SEM imaging and NMR spectroscopy in the solution (THF-d₈) and solid state.

### 1.2 BET Analysis

The specific surface area of the sMMAO samples was determined by analysis of N₂ gas physisorbtion using Brunauer-Emmett-Teller (BET) theory. The BET data obtained (FIG. 1) are consistent with a Type II isotherm which is typically given by inert gas physisorbtion on macroporous adsorbents. Interestingly the BET surface area of sMMAO(0.025/M) samples (21.5-34.0 m² mmol_{Al}⁻¹) are significantly higher than that of the control (16.6 m² mmol_{Al}⁻¹) and of the commercially supplied TOSOH sMAO (17.8 m² mmol_{Al}⁻¹). This increase in specific surface area is consistent with the proposed exchange of peripheral methyl groups with the bifunctional linker groups, which creates ‘channels’ on the sMMAO surface, and increases its porosity.

### 1.3 Diffuse-Reflectance FT-IR Spectroscopy (DRIFTs)

The DRIFT spectrum of sMMAO(0.05/1,4-HO(C₆F₄)OH) (FIG. 2) shows a new IR band at 1656 cm⁻¹ assigned to the aromatic ring stretching modes v(Cₛₚ₂═Cₛₚ₂) of the bridging C₆F₄ group. No additional bands were observed in the hydroxyl region of the DRIFT spectrum (3550-3200 cm⁻¹) suggesting both of the 0-H functionalities of the linker molecule have been deprotonated.

### 1.4 Solution NMR Spectroscopy

The linked sMMAO samples were sparingly soluble in THF-d₈, allowing for their characterisation by solution NMR spectroscopy. A selected region of the ¹H NMR spectrum of sMMAO(0.025/1,4-HO(C₆F₄)OH) is shown in FIG. 3, as a representative example.

The ¹H NMR spectrum shows a resonance between 0.03 and −1.57 ppm, assigned to the methyl protons of the solid MAO, which is very broad due to the oligomeric nature of the material. Within this broad feature is a sharp signal at −0.60 ppm, which is assigned to the methyl protons of TMA ‘bound’ within the sMAO structure. The sharp signal at −0.96 ppm is assigned to ‘free’ TMA, which is an inherent part of MAO compositions. The sMMAO samples all show an additional signal in the region −0.6 to −0.8 ppm, which is assigned to an aluminoxane methyl group adjacent to a modifier group in the oligomeric chain. In the ¹H NMR spectrum of sMMAO(0.025/1,4-HO(C₆F₄)OH) this appears as a low intensity broad resonance at −0.85 ppm (FIG. 3).

¹⁹F{¹H} NMR spectroscopy is a powerful characterisation technique in the case of the fluorinated modifiers, in order to determine the symmetry and chemical environment of the linker groups. The ¹⁹F{¹H} NMR spectrum of sMMAO(0.025/1,4-HO(C₆F₄)OH) (FIG. 4) shows a single resonance at δ_{F} −167.6 ppm consistent with a —O(C₆F₄)O— fragment which is symmetrically bound between two aluminoxane groups.

In the case of sMMAO(0.05/1,4-HOOC(C₈F₄)COOH) with modifying linker tetrafluoroterephthalic acid, the ¹H NMR spectrum showed sharp resonances that may be assigned to ‘free’ and ‘bound’ TMA methyl groups. However, the broad resonance attributed to the oligomeric sMAO methyl groups was not observed, perhaps suggesting either that a methylaluminoxane-based material was not formed, or that its solubility in THF-d₈ was extremely low.

In the case of sMMAO(0.05/1,4-HOOC(C₆F₄)COOH) with modifying linker tetrafluoroterephthalic acid, the ¹⁹F NMR spectrum showed a single weak intensity resonance at δ_{F}−143.3 ppm. The low signal intensity of this resonance is attributed to the very poor solubility in THF-d₈ of this sample. For comparison, the ¹⁹F NMR spectrum of the starting material 1,4-HOOC(C₆F₄)COOH in THF-d₈ showed a single resonance at δ_{F} −141.0 ppm. The slight shift in δ_{F} suggests a reaction may have taken place, to yield a sMMAO that features a symmetrical —OOC(C₆F₄)COO— linking group. However, due to the poor solubility of this material, solid state NMR studies are required to confirm this postulate.

### 1.5 Solid State NMR Spectroscopy

Solid state NMR spectroscopy allows for characterisation of poorly soluble samples 1,4-HO(C₆F₄)OH. FIG. 5 shows the ¹⁹F DEPTH spectrum sMMAO(0.05/1,4-HO(C₆F₄)OH), with a broad resonance at isotropic chemical shift −162 ppm confirming incorporation of the fluorinated aryl group in the linked sMMAO. In general for all the sMMAOs there is good agreement in the chemical shift values between the solution and solid state ¹⁹F NMR data.

The ¹³C-¹H CP-MAS SSNMR spectrum of sMMAO(0.05/1,4-HO(C₆F₄)OH) (FIG. 6) shows resonances at −8.7 and 177 ppm assigned to the methyl ¹³C of the aluminoxane backbone and the α-¹³C of benzoate residues in the proposed structure respectively. There are several broad resonances in the aromatic region of the spectrum (140-125 ppm) and are assigned to the phenyl ¹³C nuclei of the benzoate residues and the aryl ¹³C nuclei of the —O(C₆F₄)O— linker groups in the proposed structure. The cross-polarisation nucleus in the ¹³C CP-MAS experiment was changed from ¹H to ¹⁹F, which selectively transfers its polarisation to ¹³C atoms in close proximity to the ¹⁹F nucleus. The ¹³C—{¹⁹F} CP-MAS SSNMR spectrum of sMMAO(0.05/1,4-HO(C₆F₄)OH) (FIG. 7) shows two resonances at 132.9 and 120.0 ppm, which are assigned to the ipso and ortho-carbon atoms of the aryloxide modifying group which symmetrically bridges aluminoxane units in the proposed structure.

### 1.6. XPDF

Total X-ray scattering pair distribution function (XPDF) of amorphous sMAO and linker modified sMMAO supports was used as an additional characterisation technique. Samples linker modified sMMAOs were sealed under argon in glass capillaries and were subject to total X-ray scattering measurements using a synchrotron radiation, resulting in a useable Q-range from 0.4-12 Å⁻¹. The pair distribution function (PDF) was obtained by subtracting scattering from the argon-filled sample container and Fourier transforming the corrected total X-ray scattering data in GudrunX. The PDF for sMMAO(1,4-HO(C₆F₄)OH) samples reveals a D(r) increase at 1.34, 2.36, 2.84 and 3.62 Å with increased modifier loading, and peaks are also observed in these positions in the PDF of pure HO(C₆F₄)OH linker. FIG. 15 shows a PDF overlay for sMAO (in grey, dashed line) and sMMAO(0.40/1,4-HO(C₆F₄)OH) (black, solid line) as a representative example.

The XPDF technique provides further evidence for incorporation of —O(C₆F₄)O— units in the sMMAO, which have a rigid structure and, therefore a significant effect on the PDF. The most intense peak in the sMAO sample at ca. 1.82 Å, assigned to Al—O and Al—C correlations in the aluminoxane backbone, decreases in intensity with increased modifier loading. This may be attributed to the reduced number of Al—C bonds as free trimethylaluminium reacts to forms Al—O bonds in the modified material. PDF peaks at 3.14 and 4.53 Å, assigned to Al—Al correlations in sMAO, diminish in intensity in sMMAO(1,4-HO(C₆F₄)OH) with increasing modifier loading. These peaks have been assigned to Al—Al, Al—O and C—O correlations in unmodified sMAO, and their decreasing intensity is consistent with diminishing number of Al—O—Al moieties as the modifier breaks up the aluminoxane clusters.

### 1.7. Elemental Analysis

The aluminium content in the sMMAO samples was determined by ICP-MS analysis (Table 1), which shows a progressive decrease in Al with increasing M loading from 39.5 wt % for the control sMAO to ca. 16 wt % in the sMMAO(0.40/1,4-HO(C₆F₄)OH). This is consistent with the replacement of Al-bound methyl groups with heavier modifier groups. The amount of fluorine, as quantified by elemental analysis is 22.4 wt % for sMMAO(0.40/1,4-HO(C₆F₄)OH), which corresponds to 0.49 moles of —(C₆F₄)— linker groups per mole aluminium. Thus confirming that the protonolysis reaction of with sMAO with 1,4-HO(C₆F₄)OH is quantitative with respect to the modifier loading.

TABLE 1
Elemental analysis data for 1,4-HO(C₆F₄)OH modified
sMAO supports at different modifier loadings.

| Modifier loading | Al | F |
|---|---|---|
| (mol_{M}/mol_{Al}) | (wt %) | (wt %) |
| 0 | 39.5 | — |
| 0.01 | 37.0 | 0.99 |
| 0.025 | 31.5 | 2.47 |
| 0.05 | 29.3 | 4.44 |
| 0.10 | 28.6 | 8.99 |
| 0.20 | 21.0 | 13.7 |
| 0.40 | 16.1 | 22.4 |

### Example 2—Polymerisation Studies of Modified Solid Polymethylaluminoxane

### 2.1 Loading Study with sMMAO(x/1,4-HO(C₆F₄)OH)

In order to determine which ratio of di-ol modifier to sMAO would produce the best polymerisation activity, a loading study was carried out with sMMAO(x/1,4-HO(C₅F₄)OH) where x=0.01, 0.025, 0.05 mol_{M}/mol_{Al}. (EBI)ZrCl₂ was immobilised on sMMAO(HOC₆F₄OH) at [Al]/[Zr]=200 by swirling both the complex and the support in a toluene solution (40 mL). The complex was fully immobilised as judged by a colourless supernatant solution. The results are summarised in Table 2.

TABLE 2
Characterisation data for 1,4-HO(C₆F₄)OH modified solid MAO
supports at different loadings and slurry-phase ethylene
polymerisation data with (EBI)ZrCl₂ supported catalysts.

| Modifier | | | | |
|---|---|---|---|---|
| loading | Yield | ICP-MS | BET | Activity |
| (mol_{M}/mol_{Al}) | (%) | Al (wt %) | (m² g⁻¹) | (kg_{PE}mol_{Zr}⁻¹h⁻¹) |
| 0 | 94 | 40.2 | 16.6 | 11904 |
| 0.01 | 90 | 40.0 | 33.2 | 12780 |
| 0.025 | 87 | 39.5 | 29.1 | 15405 |
| 0.05 | 91 | 37.8 | 27.8 | 3436 |

Polymerisation conditions: 10.0 mg_{CAT}, 2 bar, 50 mL hexanes, 150 mg TIBA

It is noted that for all mol ratios, the BET surface area was higher than for the unmodified control. There is a decrease in BET surface area as the modifier loading is increased, the reasons for this are unclear but may be explained by SEM imaging of the support samples. The optimum polymerisation activity is found at x=0.025 mol_{M}/mol_{Al}, so this loading was used in subsequent experiments with a range of linker modifiers.

Scanning electron microscopy (SEM) images of polyethylene samples on carbon tape (FIG. 8) reveal that the PE particle size and morphology is significantly affected by the loading of HOC₆F₄OH linker on the modified supports with respect to the control.

The polyethylene samples for x=0.01 show good morphology control with respect to the unmodified samples, but interestingly show some ‘bobble’ areas on the PE surface. By analogy with the template effect these supports have on the PE produced, these ‘bobbles’ may explain the very high BET surface area for this support (33.2 m² mmol⁻¹). The polyethylene samples for x=0.025 also show good morphology with respect to the control, but the areas of ‘bobbles’ are less pronounced on the PE surface for these imaged particles. This may explain the slightly lower BET surface area for this support (27.8 m² mmol⁻¹) relative to the PE produced from the sMMAO(0.01/HOC₆F₄OH) based catalyst. Surprisingly, the polyethylene samples for x=0.05 show a morphology which is very different from the control. The more pronounced ‘knobbly’ structure is present across the PE particles, as revealed in the image at ×4000 magnification (FIG. 9). This abnormal surface structure may explain why this linked sMMAO support showed inferior ethylene polymerisation activity to the control (3436 vs. 11904 kg_{PE}mol_{Zr}⁻¹ h⁻¹ respectively).

### 2.2 Linked Modifier Catalyst Screening with sMMAO(0.025/M)

Using the synthetic protocol outlined in Example 1.1, a study into the effect of 9 aromatic di-ol modifying compounds was carried out, using a Al:M mol ratio of 0.025.

Scanning electron microscopy (SEM) images of the sMMAO(0.025/M) samples with M=HO(C₆H₄)—(C₆H₄)OH and 1,2-HO(C₆H₄)OH are shown in FIGS. 10 and 11 respectively.

To a round flask charged with sMMAO (265 mg) was added a solution of (EBI)ZrCl₂ (4.7 mg, 0.011 mmol) in toluene (3×5 mL), and the resulting orange dispersion was swirled at ambient temperature for 1 h. The mixture was allowed to settle giving a yellow solid below a colourless supernatant solution. The supernatant was removed by filtration and the remaining slurry was dried in vacuo for 3 h, to afford a free-flowing yellow solid. Total yield: 223 mg. ICP-MS: Al, 23.7 wt %; Zr, 0.48 wt %; mol_{Al}/mol_{Zr}=179.

The coloured solids were then tested for polymerisation capability, the results of which are outlined in Table 3.

TABLE 3
Characterisation data for solid MAO supports modified at
2.5 mol % loading and slurry-phase ethylene polymerisation
data with (EBI)ZrCl₂ supported catalysts.

| | Yield | BET | Activity |
|---|---|---|---|
| Modifier | (%) | (m² g⁻¹) | (kg_{PE}mol_{Zr}⁻¹ h⁻¹) |
| Control | 94 | 16.6 | 11904 |
| 1,4-HO(C₆F₄)OH | 59 | 29.1 | 15405 |
| 1,4-HOOC(C₆F₄)COOH | 89 | ^{§} | ^{§} |
| 1,4-HO(C₆H₄)OH | 76 | 24.6 | 11348 |
| 1,3-HO(C₆H₄)OH | 87 | 24.3 | 13219 |
| 1,2-HO(C₆H₄)OH | 86 | 34.0 | 8868 |
| HO(C₆H₄)—(C₆H₄)OH | 86 | 24.3 | 12805 |
| HO(C₆H₄)—CMe₂—(C₆H₄)OH | 90 | 24.3 | 9038 |
| HO(C₆H₄)—C(CF₃)₂—(C₆H₄)OH | 91 | 21.5 | 4976 |
| 2,6-(C₁₀H₆)(OH)₂ | 90 | 15.0 | 10712 |
| 2,7-(C₁₀H₆)(OH)₂ | 92 | 23.4 | 12652 |

Polymerisation conditions: 10.0 mg_{CAT}, 2 bar, 50 mL hexanes, 150 mg TIBA.
^{§}Unclear whether modifier reacted with sMAO.

Table 3 shows the average activity data for each polymerisation reaction. The polymerisation activity is boosted in the case of M=1,4-HO(C₆F₄)OH, 1,3-HO(C₆H₄)OH, HO(C₆H₄)—(C₆H₄)OH and 2,7-(C₁₀H₆)(OH)₂ (+29%, +11%, +7% and +6% respectively). The activity data suggest that an electron withdrawing aryl-fluoride modifier is not a strict requirement for a highly active catalyst support.

### 2.3. Complex Loading Study of (EBI)ZrCl₂ on sMMAO(0.025/1,4-HO(C₆F₄)OH) Supports

Using sMMAO(0.025/1,4-HO(C₆F₄)OH) as the most active support for (EBI)ZrCl₂ the effect of increasing [Zr] loading on higher surface area linker modified support was investigated. (EBI)ZrCl₂ was immobilised on sMMAO(0.025,HOC₅F₄OH) at [Al]/[Zr]=200, 150, 100, 50 by swirling at toluene slurry of complex and support at 60° C. In each case complex was fully immobilised as judged by a colourless supernatant solution. This confirms that the high surface area of sMMAO(0.025,HOC₆F₄OH) enables a higher loading of complex to be immobilised. Slurry phase ethylene polymerisation data are shown in Table 4, showing catalyst activity and productivity increases with [Al]/[Zr], hence a higher complex loading is not beneficial for the catalyst system.

TABLE 4
Slurry-phase ethylene polymerisation and GPC data for
(EBI)ZrCl₂ immobilised on 1,4-HO(C₆F₄)OH
modified sMAO supports at different complex loadings.

| [Al]/[Zr] | Productivity | Activity | M_{w} | PDI |
|---|---|---|---|---|
| (mol_{Al}/mol_{Zr}) | (kg_{PE}g_{CAT}⁻¹h⁻¹) | (kg_{PE}mol_{Zr}⁻¹h⁻¹) | (kg mol⁻¹) | (M_{w}/M_{w}) |
| 50 | 0.694 | 3265 | 75.1 | 3.7 |
| 100 | 0.856 | 7673 | 112.2 | 4.2 |
| 150 | 0.850 | 11249 | 123.0 | 4.2 |
| 200 | 0.832 | 14209 | 263.0 | 4.1 |

The GPC data for the polyethylene produced by (EBI)ZrCl₂ supported on sMMAO(0.025,HOC₆F₄OH) show that the polyethylene molecular weights decrease with increasing [Zr] complex loading, ranging from 263.0 to 75.1 kg/mol, and polydispersities that are reasonably constant between 4.1<M_{w}/Mₙ<3.7, compared with 4.2 for the control sMAO supported catalyst.

### Example 3—Scale-Up Polymerisation Studies of Modified Solid Polymethylaluminoxane

### 3.1 Scale-Up Linked Modifier Catalyst Screening with sMMAO(0.025/M)

A study into the effect of the 5 best performing aromatic di-hydroxy modifying compounds was carried out, as well as pentafluorophenol as a comparison mono-hydroxy modifier, each employing a [M]/[Al] loading of 0.025. A control sMAO support was prepared employing the same synthetic procedure, but without the addition of a modifier compound.

Scanning electron microscopy (SEM) images of the sMMAO(0.025/M) samples with M=1,4-HO(C₆F₄)OH, 1,4-HO(C₆H₄)OH and HO(C₆H₄)—(C₆H₄)OH are shown in FIGS. 12, 13 and 14 respectively.

The complex (EBI)ZrCl₂, was immobilised on the surface of linked sMMAO(0.025/M) supports to afford yellow coloured solid below a colourless toluene supernatant solution. The coloured solids were isolated by filtration and dried in vacuo for 3 hours. All immobilised catalysts were characterised by ICP-MS analysis and tested for slurry-phase ethylene polymerisation capability using a 2 litre reactor.

The polymerisation data (Table 5) show that sMMAO(0.025/1,4-HO(C₆F₄)OH) is the most active support for the (EBI)ZrCl₂ immobilised catalyst, showing +40% and +17% increases in activity with respect to the control sMAO and sMMAO(0.025/C₆F₅OH) supports respectively.

TABLE 5
Characterisation data for solid MAO supports modified
at 2.5 mol % loading and slurry-phase ethylene
polymerisation data with (EBI)ZrCl₂ supported catalysts.

| | | ICP-MS | (EBI)ZrCl₂ |
|---|---|---|---|
| | ICP-MS | catalyst | catalyst |
| | support | (mol_{Al}/ | activity |
| Modifier | (wt % Al) | mol_{Zr}) | (kg_{PE}mol_{Zr}⁻¹h⁻¹) |
| Control | 35.2 | 157 | 116285 |
| C₆F₅OH | 31.6 | 226 | 139576 |
| 1,4-HO(C₆F₄)OH | 31.5 | 179 | 163218 |
| 1,4-HO(C₆H₄)OH | 32.7 | 178 | 99505 |
| 1,3-HO(C₆H₄)OH | 35.2 | 178 | 81716 |
| HO(C₆H₄)—(C₆H₄)OH | 33.7 | 178 | 103083 |
| 2,7-(C₁₀H₆)(OH)₂ | 28.2 | 195 | 108411 |

Polymerisation conditions: 25.0 mg_{CAT}, 8 bar, 1000 mL hexanes, 2.5 mL TEA.

While specific embodiments of the invention have been described herein for the purpose of reference and illustration, various modifications will be apparent to a person skilled in the art without departing from the scope of the invention as defined by the appended claims.

1. A modified solid polymethylaluminoxane, the modified solid polymethylaluminoxane comprising:
a solid polymethylaluminoxane comprising a repeating moiety having a structure according to formula (I) shown below: 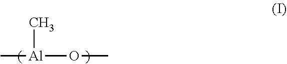
and at least one organic modifier having a structure according to formula (II) shown below: 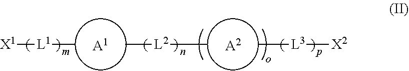
wherein
X¹ and X² are independently selected from OH, COOH, SH, PR^{x}R^{y}H and NR^{x}H, or their deprotonated forms;
rings A¹ and A² are independently aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl;
L¹, L² and L³ are independently selected from (1-5C)alkylene and phenylene, and are optionally substituted with one or more groups selected from OH, halo, (1-3C)alkyl and (1-3C)haloalkyl;
R^{x} and R^{y} are independently selected from hydrogen and (1-4C)alkyl;
m is 0 or 1;
n is 0 or 1;
o is 0 or 1; and
p is 0 or 1;
and wherein at least a portion of the solid polymethylaluminoxane is associated with the organic modifier.

2. The modified solid polymethylaluminoxane of claim 1, wherein the association between the solid polymethylaluminoxane and the organic modifier is as a result of one or more of ionic, covalent, hydrogen bonding and Van der Waals interactions.

3. The modified solid polymethylaluminoxane of claim 1 or 2, wherein at least a portion of the solid polymethylaluminoxane is covalently bonded to the organic modifier, such that at least a portion of the modified solid polymethylaluminoxane has a structure according to formula (III) shown below: 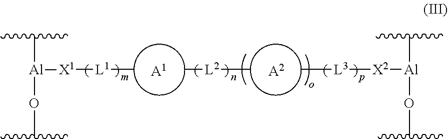
wherein
X¹ and X² are independently selected from O, COO, S, PR^{x}R^{y} and NR^{x}; and
A¹, A², L¹, L², L³, R^{x}, R^{y}, m, n, o and p are as defined in claim 1.

4. The modified solid polymethylaluminoxane of any preceding claim, wherein rings A¹ and A² are independently monocyclic or bicyclic aromatic or heteroaromatic, and are optionally substituted with one or more groups R¹ selected from OH, COOH, NR^{x}R^{y}, halo, (1-5C)alkyl, (2-5C)alkenyl, (2-5C)alkynyl, (1-5C)alkoxy, aryl and heteroaryl, wherein R^{x} and Rare independently selected from hydrogen and (1-4C)alkyl.

5. The modified solid polymethylaluminoxane of any preceding claim, wherein rings A¹ and A² are independently monocyclic or bicyclic aromatic or heteroaromatic, and are optionally substituted with one or more groups R¹ selected from OH, COOH, NR^{x}R^{y}, halo, (1-5C)alkyl, (1-5C)alkoxy, phenyl and 5-6 membered heteroaryl, wherein R^{x} and Rare independently selected from hydrogen and (1-4C)alkyl.

6. The modified solid polymethylaluminoxane of any preceding claim, wherein rings A¹ and A² are independently monocyclic or bicyclic aromatic, and are optionally substituted with one or more groups R¹ selected from OH, COOH, NR^{x}R^{y}, halo, (1-5C)alkyl, (1-5C)alkoxy, phenyl and 5-6 membered heteroaryl, wherein R^{x} and Rare independently selected from hydrogen and (1-4C)alkyl.

7. The modified solid polymethylaluminoxane of any preceding claim, wherein rings A¹ and A² are independently phenyl or naphthyl, and are optionally substituted with one or more groups R¹ selected from OH, COOH, NR^{x}R^{y}, halo, (1-5C)alkyl, (1-5C)alkoxy and phenyl, wherein R^{x} and R^{y} are independently selected from hydrogen and (1-4C)alkyl.

8. The modified solid polymethylaluminoxane of any preceding claim, wherein rings A¹ and A² are independently phenyl or naphthyl, and are optionally substituted with one or more groups R¹ selected from OH, halo, (1-5C)alkyl and phenyl.

9. The modified solid polymethylaluminoxane of any preceding claim, wherein rings A¹ and A² are independently phenyl or naphthyl, and are optionally substituted with one or more groups R¹ selected from OH, chloro, fluoro and (1-3C)alkyl.

10. The modified solid polymethylaluminoxane of any preceding claim, wherein rings A¹ and A² are independently phenyl, and are substituted with one, two, three or four groups R¹ selected from chloro and fluoro.

11. The modified solid polymethylaluminoxane of any preceding claim, wherein rings A¹ and A² are independently phenyl, and are substituted with three or four groups R¹ being fluoro.

12. The modified solid polymethylaluminoxane of any preceding claim, wherein rings A¹ and A² independently have any one the following structures: 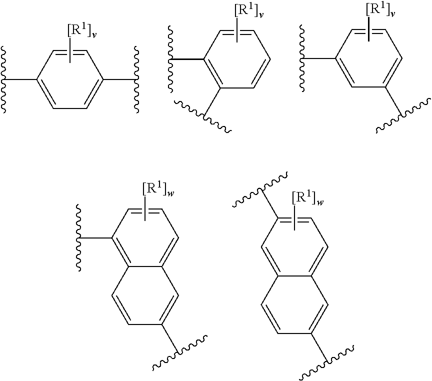
wherein
R¹ is as defined in any preceding claim (e.g. halo, such as fluoro),
v is 0 to 4 (e.g. 0 or 4), and
w is 0 to 6.

13. The modified solid polymethylaluminoxane of any preceding claim, wherein rings A¹ and A² independently have any one the following structures: 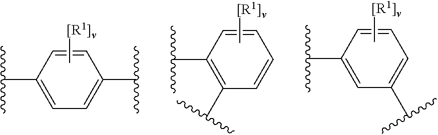
wherein
R¹ is as defined in any preceding claim (e.g. fluoro), and
v is 0 to 4 (e.g. 0 or 4).

14. The modified solid polymethylaluminoxane of any preceding claim, wherein rings A¹ and A² independently have the following structure: 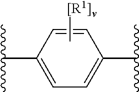
wherein
R¹ is as defined in any preceding claim (e.g. fluoro), and
v is 0 to 4.

15. The modified solid polymethylaluminoxane of claim 12, 13 or 14, wherein R¹ is fluoro.

16. The modified solid polymethylaluminoxane of any one of claims 12 to 15, wherein v is 0 or 4.

17. The modified solid polymethylaluminoxane of any one of claims 12 to 15, wherein v is 1, 2, 3 or 4 (e.g. 3 or 4).

18. The modified solid polymethylaluminoxane of any one of claims 12 to 17, wherein w is 0.

19. The modified solid polymethylaluminoxane of any preceding claim, wherein L¹, L² and L³ are independently selected from (1-3C)alkylene and phenylene, and are optionally substituted with one or more groups selected from OH, halo, (1-3C)alkyl and (1-3C)haloalkyl.

20. The modified solid polymethylaluminoxane of any preceding claim, wherein L¹, L² and L³ are independently (1-3C)alkylene, and are optionally substituted with one or more groups selected from halo, (1-3C)alkyl and (1-3C)haloalkyl.

21. The modified solid polymethylaluminoxane of any preceding claim, wherein L¹, L² and L³ are independently (1-3C)alkylene, and are optionally substituted with one or more groups selected from (1-3C)alkyl and (1-3C)haloalkyl.

22. The modified solid polymethylaluminoxane of any preceding claim, wherein L¹, L² and L³ are methylene, and are optionally substituted with one or more groups selected from (1-2C)alkyl and (1-2C)fluoroalkyl.

23. The modified solid polymethylaluminoxane of any preceding claim, wherein m is 0.

24. The modified solid polymethylaluminoxane of any preceding claim, wherein p is 0.

25. The modified solid polymethylaluminoxane of any preceding claim, wherein n is 1 and o is 1.

26. The modified solid polymethylaluminoxane of any preceding claim, wherein m, n, o and p are 0.

27. The modified solid polymethylaluminoxane of claim 1, wherein
X¹ and X² are independently selected from OH and COOH (e.g. OH), or their deprotonated forms;
ring A¹ is unsubstituted phenyl or phenyl substituted with one, two, three or four (e.g. three or four) groups R¹ selected from chloro and fluoro (e.g. fluoro); and
m, n, o and p are 0.

28. The modified solid polymethylaluminoxane of claim 1, wherein
X¹ and X² are OH or its deprotonated form;
ring A¹ is phenyl substituted with three or four groups R¹ being fluoro; and
m, n, o and p are 0.

29. The modified solid polymethylaluminoxane of claim 1, wherein
X¹ and X² are OH or its deprotonated form;
ring A¹ has any one of the following structures: 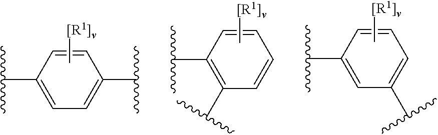
wherein
each R¹ is independently chloro or fluoro (e.g. fluoro), and
v is 0, 1, 2, 3 or 4 (e.g. 0, 3 or 4); and
m, n, o and p are 0.

30. The modified solid polymethylaluminoxane of claim 1, wherein
X¹ and X² are OH or its deprotonated form;
ring A¹ has the following structure: 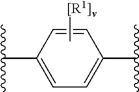
wherein
each R¹ is independently chloro or fluoro (e.g. fluoro), and
v is 0, 1, 2, 3 or 4 (e.g. 0, 3 or 4); and
m, n, o and p are 0.

31. The modified solid polymethylaluminoxane of claim 1, wherein
X¹ and X² are OH or its deprotonated form;
ring A¹ has the following structure: 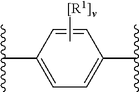
wherein
each R¹ is fluoro, and
v is 3 or 4; and
m, n, o and p are 0.

32. The modified solid polymethylaluminoxane of claim 1, wherein the organic modifier has any one of the following structures: 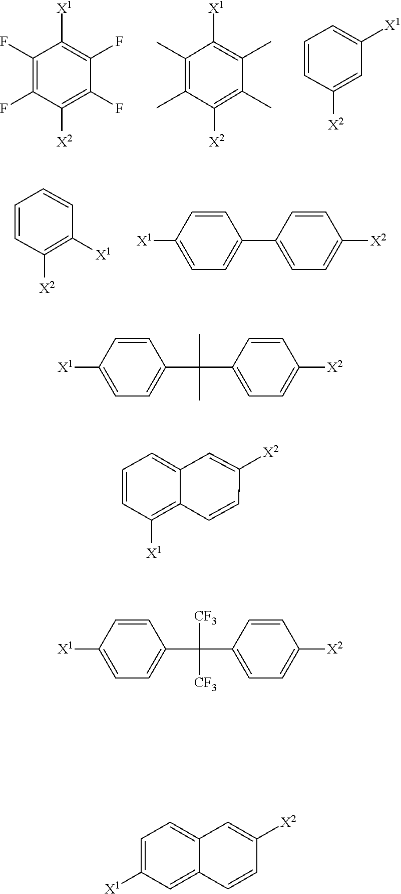
wherein X¹ and X² are independently selected from OH, COOH, SH, PR^{x}R^{y}H and NR^{x}H, or their deprotonated forms, wherein R^{x} and R^{y} are independently selected from hydrogen and (1-4C)alkyl.

33. The modified solid polymethylaluminoxane of claim 32, wherein X¹ and X² are OH or its deprotonated form.

34. The modified solid polymethylaluminoxane of any preceding claim, wherein the modified solid polymethylaluminoxane comprises 0.1-45 mol % of organic modifier of formula (II) relative to the number of moles of aluminium within the solid polymethylaluminoxane comprising a repeating moiety of formula (I)

35. The modified solid polymethylaluminoxane of any preceding claim, wherein the modified solid polymethylaluminoxane comprises 0.5-15 mol % of organic modifier of formula (II) relative to the number of moles of aluminium within the solid polymethylaluminoxane comprising a repeating moiety of formula (I).

36. The modified solid polymethylaluminoxane of any preceding claim, wherein the modified solid polymethylaluminoxane comprises 1-5 mol % of organic modifier of formula (II) relative to the number of moles of aluminium within the solid polymethylaluminoxane comprising a repeating moiety of formula (I).

37. The modified solid polymethylaluminoxane of any preceding claim, wherein the modified solid polymethylaluminoxane comprises 1.5-3.5 mol % of organic modifier of formula (II) relative to the number of moles of aluminium within the solid polymethylaluminoxane comprising a repeating moiety of formula (I).

38. The modified solid polymethylaluminoxane of any preceding claim, wherein the modified solid polymethylaluminoxane comprises 2.0-3.0 mol % of organic modifier of formula (II) relative to the number of moles of aluminium within the solid polymethylaluminoxane comprising a repeating moiety of formula (I).

39. The modified solid polymethylaluminoxane of any preceding claim, wherein the modified solid polymethylaluminoxane comprises 2.2-2.8 mol % of organic modifier of formula (II) relative to the number of moles of aluminium within the solid polymethylaluminoxane comprising a repeating moiety of formula (I).

40. The modified solid polymethylaluminoxane of any preceding claim, wherein the modified solid polymethylaluminoxane comprises 2.35-2.65 mol % of organic modifier of formula (II) relative to the number of moles of aluminium within the solid polymethylaluminoxane comprising a repeating moiety of formula (I).

41. The modified solid polymethylaluminoxane of any preceding claim, wherein the solubility in n-hexane and/or toluene at 25° C. of the solid polymethylaluminoxane is 0-2 mol %.

42. The modified solid polymethylaluminoxane of any preceding claim, wherein the aluminium content of the solid polymethylaluminoxane and/or the modified solid polymethylaluminoxane falls within the range of 36-41 wt %.

43. A process for the preparation of a modified solid polymethylaluminoxane as claimed in any preceding claim, the process comprising the step of:
a) providing a solid polymethylaluminoxane comprising a repeating moiety having a structure according to formula (I) shown below: 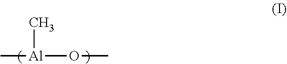
wherein the solid polymethylaluminoxane is provided in a first solvent;
b) contacting the solid polymethylaluminoxane of step a) with at least one organic modifier having a structure according to formula (II) shown below: 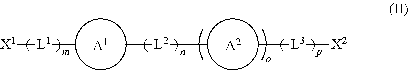
wherein
X¹, X², A¹, A², L¹, L², L³, m, n, o and p are as defined in any preceding claim;
c) isolating the product formed from step b)
wherein the mole ratio of the organic modifier to the aluminium in the solid polymethylaluminoxane in step b) ranges from 0.001:1 to 0.45:1.

44. The process of claim 43, wherein the mole ratio of the organic modifier to the aluminium in the solid polymethylaluminoxane in step b) ranges from 0.005:1 to 0.15:1.

45. The process of claim 43 or 44, wherein the mole ratio of the organic modifier to the aluminium in the solid polymethylaluminoxane in step b) ranges from 0.01:1 to 0.05:1.

46. The process of claim 43, 44 or 45, wherein the mole ratio of the organic modifier to the aluminium in the solid polymethylaluminoxane in step b) ranges from 0.015:1 to 0.035:1.

47. The process of any one of claims 43 to 46, wherein the mole ratio of the organic modifier to the aluminium in the solid polymethylaluminoxane in step b) ranges from 0.02:1 to 0.03:1.

48. The process of any one of claims 43 to 47, wherein the mole ratio of the organic modifier to the aluminium in the solid polymethylaluminoxane in step b) ranges from 0.022:1 to 0.028:1.

49. The process of any one of claims 43 to 48, wherein the mole ratio of the organic modifier to the aluminium in the solid polymethylaluminoxane in step b) ranges from 0.0235:1 to 0.0265:1.

50. The process of any one of claims 43 to 49, wherein the organic modifier is provided in a second solvent, and wherein step b) comprises mixing the first solvent and the second solvent.

51. The process of any one of claims 43 to 50, wherein the first solvent is selected from toluene, benzene and hexane.

52. The process of claim 50 or 51, wherein the second solvent is selected from toluene, benzene and hexane.

53. The process of any one of claims 43 to 52, wherein step b) is conducted at a temperature of 10-150° C.

54. The process of any one of claims 43 to 53, wherein step b) is conducted at a temperature of 10-65° C.

55. The process of any one of claims 43 to 54, wherein step b) is conducted at a temperature of 18-50° C.

56. The process of any one of claims 43 to 55, wherein step b) is conducted at a temperature of 18-35° C.

57. The process of any one of claims 43 to 56, wherein step b) further comprises the step of sonicating the mixture of the solid polymethylaluminoxane and the organic modifier.

58. The process of claim 57, wherein step b) further comprises the step of sonicating the mixture of the solid polymethylaluminoxane and the organic modifier for a period of 0.1 to 24 hours.

59. The process of claim 58, wherein step b) further comprises the step of sonicating the mixture of the solid polymethylaluminoxane and the organic modifier for a period of 0.1 to 5 hours.

60. The process of claim 57, 58 or 59, wherein the ultrasonic frequency is >15 kHz.

61. A modified solid polymethylaluminoxane obtainable by the process of any one of claims 43 to 60.

62. A catalytic composition comprising an olefin polymerisation catalyst supported on a modified solid polymethylaluminoxane as defined in any one of claims 1 to 42 and 61.

63. The catalytic composition of claim 62, wherein the olefin polymerisation catalyst is a metallocene-based Ziegler Natta catalyst.

64. The catalytic composition of claim 62 or 63, wherein the olefin polymerisation catalyst has one of the following structures:

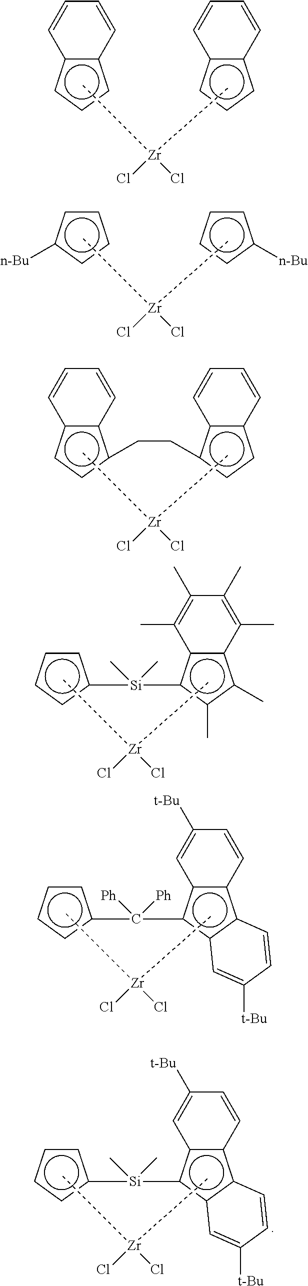

65. The catalytic composition of claim 62, 63 or 64, wherein the olefin polymerisation catalyst has the following structure:

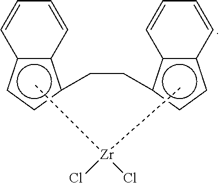

66. The catalytic composition of any one of claims 62 to 65, wherein mol_{Al}/mol_{X} is 100-225.

67. The catalytic composition of any one of claims 62 to 66, wherein mol_{Al}/mol_{X} is 150-225.

68. The catalytic composition of any one of claims 62 to 67, wherein mol_{Al}/mol_{X} is 175-225.

69. A process for the preparation of a polyolefin, the process comprising the step of:
a) contacting olefin monomers with a catalytic composition as claimed in any one of claims 62 to 68.
